(19) United States
(12) Patent Application Publication
(10) Pub. No.: US 2026/0216881 A1
(43) Pub. Date: Jul. 30, 2026

(54) CALIBRATION METHOD, CALIBRATION SYSTEM, AND ELECTRONIC DEVICE

(71) Applicant: The Hong Kong Polytechnic University, Hong Kong (CN)

(72) Inventor: Peng-fei Fu, Hong Kong (CN)

(73) Assignee: The Hong Kong Polytechnic University, Hong Kong (CN)

(21) Appl. No.: 19/446,177

(22) Filed: Jan. 12, 2026

Related U.S. Application Data
(60) Provisional application No. 63/749,798, filed on Jan. 27, 2025.

(51) Int. Cl. B25J 9/16

(52) U.S. Cl. CPC B25J 9/1692; B25J 9/1697

(57) ABSTRACT

A calibration method includes: installing an image acquisition device on a first robot and a calibration device on a second robot; obtaining motion trajectories of the first robot and the second robot; controlling the first robot and the second robot to move to first predetermined poses, and acquiring a first calibration image; obtaining, according to the first calibration image, a first relative pose between the calibration device and the image acquisition device at the first predetermined detection point; controlling, according to the first relative pose, the first robot and/or the second robot to adjust until the first relative pose between the calibration device and the image acquisition device meets an alignment condition; recording a corrected pose between the first robot and the second robot; and controlling the first robot and the second robot to move to second predetermined poses relative to the second predetermined detection point.

### CROSS-REFERENCE

The present application is based upon and claims priority to U.S. Provisional Patent Application No. 63/749,798, filed Jan. 27, 2025, which is herein incorporated by reference in its entirety.

### TECHNICAL FIELD

The present disclosure relates to the field of calibration and detection technologies, and in particular, to a calibration method, a calibration apparatus, a calibration system, an electronic device, a computer-readable storage medium, and a computer program product.

### BACKGROUND

It is a difficult task to precisely align two or more robots in free space with no other external references. Typically, laser trackers and other expensive equipment are used with varying degrees of success. It is difficult with the laser trackers to achieve the precise alignment in the lateral plane (position) simultaneously with the simultaneous calibration of the tilt axes (orientation). Accordingly, the laser trackers are used more to calibrate/align the base of the robot, where the position and orientation accuracy of the final axis often depends on assumptions.

### SUMMARY

Embodiments of the present disclosure provide a calibration method, including: installing an image acquisition device at an end of a first robot and a calibration device at an end of a second robot; obtaining motion trajectories of the first robot and the second robot, wherein the motion trajectories correspond to N predetermined detection points, where N is an integer greater than 1, and the N predetermined detection points include a first predetermined detection point and a second predetermined detection point; controlling the first robot and the second robot to move to first predetermined poses relative to the first predetermined detection point, and using the image acquisition device to acquire a first calibration image of the calibration device; obtaining, according to the first calibration image, a first relative pose between the calibration device and the image acquisition device at the first predetermined detection point; controlling, according to the first relative pose, the first robot and/or the second robot to adjust until the first relative pose between the calibration device and the image acquisition device meets an alignment condition at the first predetermined detection point; recording a corrected pose between the first robot and the second robot relative to the first predetermined detection point; and controlling the first robot and the second robot to move to second predetermined poses relative to the second predetermined detection point until N corrected poses of the N predetermined detection points are obtained.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flowchart of a calibration method according to an example embodiment of the present disclosure.

FIG. 2 is a schematic structural diagram of an example dual-robot system of the present disclosure.

FIG. 3 is a schematic structural diagram of another example dual-robot system of the present disclosure.

FIG. 4 is a schematic structural diagram of a calibration system according to an example embodiment of the present disclosure.

FIG. 5 is a schematic structural diagram of a calibration system according to another example embodiment of the present disclosure.

FIGS. 6 to 8 are schematic diagrams of the alignment of an image acquisition device and a calibration device according to an example embodiment of the present disclosure.

FIG. 9 is an exploded schematic diagram of an image acquisition device according to an example embodiment of the present disclosure.

FIG. 10 is an exploded schematic diagram of a calibration device according to an example embodiment of the present disclosure.

FIG. 11 is a schematic diagram of the architecture of a radome test system according to an example embodiment of the present disclosure.

FIGS. 12 and 13 are schematic diagrams of the use of a radome test system to detect a radome according to an example embodiment of the present disclosure.

FIGS. 14 to 17 are schematic diagrams of the alignment of two test antennas according to an example embodiment of the present disclosure.

FIG. 18 is an exploded schematic diagram of a test antenna according to an example embodiment of the present disclosure.

FIG. 19 is a schematic structural diagram of a one-horn mode according to an example embodiment of the present disclosure.

FIG. 20 is a schematic structural diagram of a dual-horn mode according to an example embodiment of the present disclosure.

FIG. 21 is a schematic structural diagram of a multi-horn mode according to an example embodiment of the present disclosure.

FIG. 22 is a schematic diagram of waveforms of alignment effects before and after calibration according to an example embodiment of the present disclosure.

FIG. 23 is a schematic diagram of an elevation/azimuth radar gimbal according to an example embodiment of the present disclosure.

FIG. 24 is a schematic diagram of transmission efficiency test results of a radome according to an example embodiment of the present disclosure.

FIG. 25 is a schematic diagram of the architecture of a radome test system according to another example embodiment of the present disclosure.

FIG. 26 is a flowchart of a calibration method according to another example embodiment of the present disclosure.

FIG. 27 is a schematic structural diagram of an example multi-robot system of the present disclosure.

FIG. 28 is a schematic structural diagram of another example multi-robot system of the present disclosure.

FIG. 29 is a schematic structural diagram of an example calibration apparatus of the present disclosure.

### DETAILED DESCRIPTION

To make the objectives, technical solutions, and advantages of the present disclosure more apparent, example embodiments according to the present disclosure will now be described in detail with reference to the accompanying drawings. In the drawings, the same reference numerals denote the same components throughout. It should be understood that the embodiments described herein are merely illustrative and should not be construed as limiting the scope of the present disclosure.

In embodiments of the present disclosure, the term “module” or “unit” refers to a computer program that has a predetermined function or a part thereof, and works with other related parts to achieve a predetermined goal, and can be implemented wholly or partially using software, hardware (such as processing circuitry or memory), or a combination thereof. Similarly, a processor (or multiple processors or memories) can be used to implement one or more modules or units. Furthermore, each module or unit can be part of an overall module or unit that includes the functionality of that module or unit.

In the present disclosure, the terms “first”, “second”, and “third” are used for descriptive purposes only and should not be construed as indicating or implying relative importance; the term “multiple” or “a plurality of . . . ” refers to two or more unless otherwise expressly defined. The terms “install”, “couple”, “connect”, “fix” and the like should be interpreted broadly. For example, “couple” can be a fixed coupling, a detachable coupling, or an integral coupling; “connect” can be a direct connection or an indirect connection through an intermediate medium. Those skilled in the art can understand the specific meaning of the above terms in the present disclosure according to the specific circumstances.

In the description of this specification, the terms “an embodiment”, “some embodiments”, “a specific embodiment”, etc., mean that a specific feature, structure, material, or characteristic described in connection with that embodiment or example is included in at least one embodiment or example of the present disclosure. In this specification, the illustrative expressions of the above terms do not necessarily refer to the same embodiment or example. Furthermore, the specific features, structures, materials, or characteristics described may be combined in any suitable manner in one or more embodiments or examples.

The above description is merely a preferred embodiment of the present disclosure and is not intended to limit the present disclosure. Various modifications and variations can be made to the present disclosure by those skilled in the art. Any modifications, equivalent substitutions, improvements, etc., made within the spirit and principles of the present disclosure should be included within the scope of protection of the present disclosure.

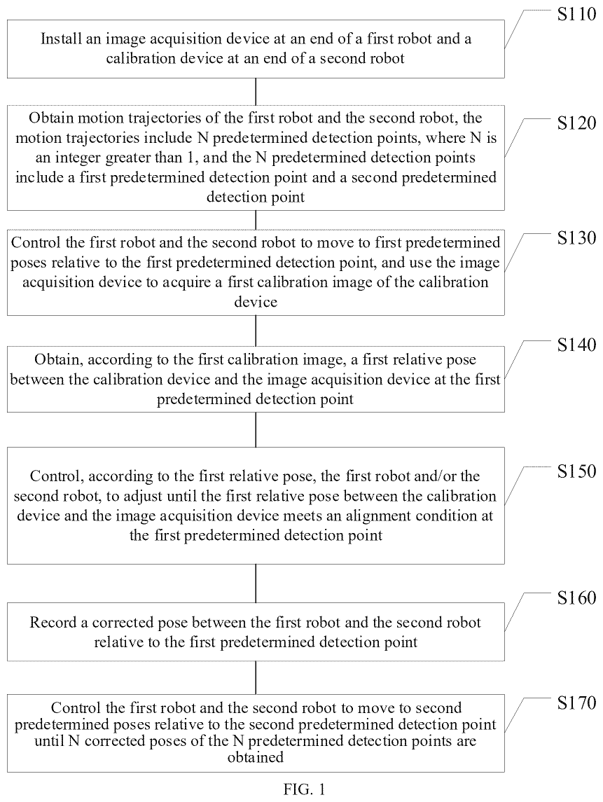

As shown in FIG. 1, a calibration method provided in embodiments of the present disclosure includes steps S110 to S170. It should be noted that the method provided in the embodiment of the present disclosure can be applied to dual-robot calibration or multi-robot (three or more) robot calibration. The first robot and the second robot described below can be two robots in a dual-robot system, or any two robots in a multi-robot system.

Embodiments of the present disclosure do not limit the specific mechanical structure of the robot, and the robot can be any device capable of moving and performing operation tasks in the three-dimensional space. In some embodiments, the robot can be a device with environmental perception and autonomous movement capabilities. The robot can include, but is not limited to, industrial robot arms, mobile robots, and biomimetic robots. The robot may include a base, a multi-degree-of-freedom robot arm disposed on the base, and a controller configured to control a trajectory of an end effector (such as the tool described below) of the robot arm.

In S110, an image acquisition device is installed at an end of the first robot, and a calibration device is installed at an end of the second robot.

In embodiments of the present disclosure, the end of the robot (including the end of the first robot, the end of the second robot, and in other embodiments, in a multi-robot (three or more robots) system, an end of a third robot can also be included, etc.) refers to a mechanical interface of the last joint of the robot, which can be a flange, and it is a fixed physical part belonging to a robot body, and serves as a base for connecting a tool. Its function is to mount the tool, such as the image acquisition device, the calibration device, a test antenna, a metal plate, a welding torch, a gripper, a spray gun, a sander, etc.

In some embodiments, the first robot and the second robot work collaboratively. Both the first robot and the second robot include the axis 6/final axis, which refers to the last rotary joint of the robot's kinematic chain and its driven flange, which is directly connected to the tool or load (such as a radar horn antenna), controls the spatial attitude orientation (especially the roll around the Z-axis) of the tool or load, and enables precise angular adjustments of the tool around its own axis.

In embodiments of the present disclosure, the Tool Centre Point (TCP) is a virtual point defined on the tool installed on the robot. It is not a physical component, but rather the origin of a defined and measured coordinate system. It represents the tool's working point or point of action. In the embodiments of the present disclosure, the robot's motion is controlled to ensure that the TCP of the tool installed at the end of the robot reaches a designated position and maintains the correct orientation.

For example, when the image acquisition device is installed at the end of the first robot, the image acquisition device serves as a sensor tool that the robot grasps. The TCP (referred to as a first tool center point or a first TCP) of the image acquisition device can be located near an optical center (the principal point of the lens) of the image acquisition device, and the light emitted from this point follows a perspective model of the image acquisition device. When pixel coordinates of a point in space within an image acquired by the image acquisition device are known, in combination with the TCP of the image acquisition device, a line of sight originating from the TCP can be constructed. In some other embodiments, for ease of measurement, the TCP of the image acquisition device can be defined at a corner of the device's housing or at the center of its mounting surface; however, this requires additional conversion during visual computation. When the first robot moves along with the image acquisition device to a specific viewing angle (e.g., perpendicular to a surface of an object under test), it controls the position and orientation (or simply pose) of the TCP of the image acquisition device.

In embodiments of the present disclosure, the image acquisition device is a device capable of converting optical information in physical space into digital or analog signals that can be understood by a processor or controller, and may include a camera, an image capturing device, a scanning device, etc. In the following embodiments, the camera is used as an example.

In embodiments of the present disclosure, the calibration device is used to provide a spatial reference for the image acquisition device. Its surface or interior contains one or more identifiable feature patterns with known geometric dimensions and distributions, including checkerboards, dot arrays, Charuco boards, etc. The Charuco board is used as an example below.

For another example, when the calibration device is installed at the end of the second robot, the calibration device is an observed passive object and is not a tool itself. For ease of calibration and measurement, a reference coordinate system similar to the TCP (called a second tool center point or a second TCP) is defined for the calibration device, which is called a calibration board coordinate system or a workpiece coordinate system. This TCP can be defined at a fixed feature point on the calibration board, or at a feature point on a pattern of the calibration board, serving as the origin of the entire board coordinate system. It is the spatial reference point during calibration and measurement. For example, for the checkerboard, the TCP can be defined at the first interior corner point in the upper left corner (world coordinates (0,0,0)). For a dot array, the TCP can be defined at the center dot or a corner point. The Z-axis direction is perpendicular to the calibration board plane and points outwards, while the X-axis and Y-axis directions are along the row and column directions of the calibration board.

When the calibration device uses the Charuco board, a unique 3D world coordinate is assigned to each corner point on the board when the Charuco board pattern is generated, the first interior corner point is defined as (0,0,0), and coordinates of subsequent corner points are incremented by the grid rows and columns based on this. Using this point as the TCP of the calibration device ensures seamless alignment between the TCP definition and the output results of visual inspection, without any additional coordinate conversions, thus avoiding the introduction of human error. In the coordinate system of the Charuco board, the origin is the first interior corner point. The X-axis is along the first row (horizontal direction) of the board and points to the second interior corner point. The Y-axis is along the first column (vertical direction) of the board and points to the first interior corner point of the next row. The Z-axis is perpendicular to the board surface and points outward (towards the direction in which the image acquisition device is observed), defining the “front” of the board.

For example, when a first testing device is installed at the end of the first robot, if the first testing device is a test antenna, such as a horn antenna, the TCP of the first testing device can be defined at the geometric center of the radiation aperture plane of the first testing device, and the Z-axis of the TCP coordinate system coincides with the normal direction of the aperture plane, pointing towards the principal radiation direction of the antenna. The position of the TCP can be equivalently adjusted or calibrated according to the phase center of the test antenna. In some embodiments, the TCP of the first testing device can be defined at the phase center of the test antenna. The phase center is a virtual point where the spherical wavefront of the electromagnetic wave radiated by the test antenna is emitted when the electromagnetic wave is equivalent to a spherical wave in the far field. For a well-designed horn antenna, its phase center is located inside the horn or near the aperture plane.

For example, when a second testing device is installed at the end of the second robot, if the second testing device is a test antenna, such as a horn antenna, the TCP of the second testing device can be defined at the geometric center of the radiation aperture plane of the second testing device, and the Z-axis of the TCP coordinate system coincides with the normal direction of the aperture plane, pointing towards the principal radiation direction of the antenna. The position of the TCP can be equivalently adjusted or calibrated according to the phase center of the test antenna. In some embodiments, the TCP of the second testing device can be defined at the phase center of the test antenna. The phase center is a virtual point where the spherical wavefront of the electromagnetic wave radiated by the test antenna is emitted when the electromagnetic wave is equivalent to a spherical wave in the far field. For a well-designed horn antenna, its phase center is located inside the horn or near the aperture plane.

Through the calibration method provided by embodiments of the present disclosure, the TCP alignment can be achieved.

In S120, motion trajectories of the first robot and the second robot are obtained, the motion trajectory corresponds to N predetermined detection points, where N is an integer greater than 1, and the N predetermined detection points include a first predetermined detection point and a second predetermined detection point.

In embodiments of the present disclosure, the N predetermined detection points are pre-set according to a task or operation to be completed. For example, for a radome to be detected, these N predetermined detection points are distributed on a surface of the radome. After these N predetermined detection points, their normal directions relative to the radome, and a detection sequence are determined, the motion trajectories of the first robot and the second robot can be planned accordingly, so that during detection, when the first robot and the second robot are performing a task for a predetermined detection point, the first testing device held at the end of the first robot and the second testing device held at the end of the second robot are capable of being located on both sides of the predetermined detection point, with a distance between them satisfying a pre-set condition, and their orientations also satisfying pre-set conditions. For example, the distance between the first testing device and the second testing device remains constant, and the axial connecting line between them is perpendicular to the normal direction of any predetermined detection point on the radome. To achieve this ideal alignment condition as much as possible, the first robot and the second robot are first calibrated using the camera and the calibration device. The motion trajectories of the first robot and the second robot acquired during the calibration process are pre-set according to the detection task.

In S130, the first robot and the second robot are controlled to move to first predetermined poses relative to the first predetermined detection point, and the image acquisition device is used to acquire a first calibration image of the calibration device.

In the motion trajectories of the first and second robots, predetermined poses of the first and second robots are pre-set relative to each predetermined detection point. The predetermined poses are the positions and orientations, defined during the planning process, that the first and second robots should move to and attain under ideal conditions. When the first and second robots each have the first predetermined pose, the first calibration image is obtained by capturing the calibration device installed at the end of the second robot using the camera installed at the end of the first robot. The motion trajectory includes the first predetermined pose.

In S140, a first relative pose between the calibration device and the image acquisition device at the first predetermined detection point is obtained based on the first calibration image.

Taking the Charuco board as the calibration device as an example, each corner point on the Charuco board has precisely known 3D coordinates (X_{board}, Y_{board}, 0) in the board coordinate system (world coordinate system) (because the corner points are all on a plane, Z=0). In addition, the first calibration image captured by the camera can detect 2D pixel coordinates (u, v) corresponding to each corner point. Based on this, an angular deviation between the Z-axis of the calibration device and the Z-axis of the image acquisition device, an angular deviation between the X-axis of the calibration device and the X-axis of the image acquisition device, an angular deviation between the Y-axis of the calibration device and the Y-axis of the image acquisition device, a position deviation between the origin of the calibration device and the origin of the image acquisition device, and a distance deviation between the calibration device and the image acquisition device can be calculated, thereby obtaining the first relative pose between the calibration device and the image acquisition device.

In S150, the first robot and/or the second robot are controlled, based on the first relative pose, to adjust until the first relative pose between the calibration device and the image acquisition device meets an alignment condition at the first predetermined detection point.

Taking testing the radome as an example, the system pre-stores ideal poses, meaning that under ideal conditions, the calibration device and the image acquisition device are aligned, and an ideal calibration image is acquired in this case. By comparing the first relative pose with the ideal relative pose, it is determined whether the deviation between the first relative pose and the ideal relative pose meets the alignment condition. If the alignment condition is not met, the first robot and/or the second robot can be controlled to adjust their poses, and then the calibration device is photographed again by the camera to obtain a new first calibration image. Based on the new first calibration image, a new first relative pose between the calibration device and the image acquisition device is calculated, and the new first relative pose is compared with the ideal relative pose. If the alignment condition is still not met, the poses of the first robot and/or the second robot are adjusted until the alignment condition is met.

In a dual-robot alignment system, the ideal pose is defined as follows. When two robots are perfectly aligned, a relative pose between the camera and the calibration board is known (e.g., they are perfectly aligned, and a measurement distance is a fixed value), and this pose is the ideal pose. The Charuco board is photographed by the camera, and the current pose, relative pose, or actual pose is calculated. Position deviation=Current pose (X,Y,Z)−Ideal pose (X,Y,Z). Orientation deviation=Current pose (roll, pitch, yaw)−Ideal pose (roll, pitch, yaw). The calculated 6-dimensional pose deviation is sent to the robot controller, and the controller is instructed to fine-tune for precise alignment. By repeating this process multiple times throughout the workspace, the system can build an error mapping table, thereby achieving high-precision alignment across the entire workspace.

In S160, a corrected pose between the first robot and the second robot relative to the first predetermined detection point is recorded.

The corrected pose recorded here refers to a pose adjusted by the first robot and/or the second robot relative to the first predetermined pose at the first predetermined detection point to make the first relative pose between the calibration device and the image acquisition device meet the alignment condition. For example, if the alignment condition is met only after multiple adjustments to the poses of the first robot and/or the second robot, then the corrected pose refers to the deviation of the first robot and/or the second robot relative to the first predetermined pose when the alignment condition is met, including the position deviation and/or the orientation deviation.

In S170, the first robot and the second robot are controlled to move to a second predetermined pose relative to the second predetermined detection point until N corrected poses of the N predetermined detection points are obtained.

For example, the motion trajectory includes the second predetermined pose. When the first robot and the second robot each have the second predetermined pose, a second calibration image is obtained by capturing the calibration device installed at the end of the second robot using the camera installed at the end of the first robot. The second relative pose between the calibration device and the image acquisition device can be calculated based on the second calibration image. By comparing the second relative pose with the ideal relative pose, it is determined whether the deviation between the second relative pose and the ideal relative pose meets the alignment condition. If the alignment condition is not met, the first robot and/or the second robot can be controlled to adjust their poses, and then the calibration device is photographed again by the camera to obtain a new second calibration image. Based on the new second calibration image, a new second relative pose between the calibration device and the image acquisition device is calculated, and the new second relative pose is compared with the ideal relative pose. If the alignment condition is still not met, the poses of the first robot and/or the second robot are adjusted until the alignment condition is met. The corrected pose of the second predetermined detection point is recorded, and the corrected pose refers to a pose adjusted by the first robot and/or the second robot relative to the second predetermined pose at the second predetermined detection point to make the second relative pose between the calibration device and the image acquisition device meet the alignment condition. By analogy, N corrected poses of the N predetermined detection points can be obtained.

In the calibration method provided in embodiments of the present disclosure, the image acquisition device is installed at the end of the first robot and the calibration device is installed at the end of the second robot, and then the first robot acquires the corresponding calibration images at respective predetermined detection points, so that the poses of the first and second robots are calibrated based on the calibration image, improving the pose accuracy of the robots.

For example, the motion trajectory is on a curved surface, and the method further includes: determining a first normal line of the first predetermined detection point on the curved surface; and when angles between an axis (Z-axis) of the image acquisition device and an axis (Z-axis) of the calibration device and the first normal line are both less than a first angle threshold, an angle between a first horizontal axis (e.g., X-axis or Y-axis) of the image acquisition device and a first horizontal axis (e.g., X-axis or Y-axis) of the calibration device is less than a second angle threshold, and a deviation between an origin of the image acquisition device and an origin of the calibration device in a plane of the first horizontal axis and a second horizontal axis is less than a predetermined threshold, determining that the first relative pose between the calibration device and the image acquisition device meets the alignment condition at the first predetermined detection point.

In embodiments of the present disclosure, values of the first angle threshold, the second angle threshold, and the predetermined threshold can be set according to the required alignment accuracy, which are not limited by the present disclosure. The determination of alignment conditions for other predetermined detection points can refer to the determination of the first predetermined detection point, which will not be elaborated here. Through the calibration method provided in embodiments of the present disclosure, the alignment of the first tool center point and the second tool center point is achieved.

For example, the method provided in embodiments of the present disclosure includes: obtaining a first transformation matrix T1 from the image acquisition device to its first tool center point and an optical correction parameter of the image acquisition device; and obtaining a second transformation matrix T2 from the calibration device to its second tool center point. The first relative pose is obtained based on the first calibration image, the first transformation matrix T1, the optical correction parameter, and the second transformation matrix T2.

For example, M valid Charuco corner points can be extracted from the first calibration image, i.e., the 2D pixel coordinates pₚᵢₓₑₗ of M corner points in the first calibration image are known, where M is a positive integer greater than 1. The optical correction parameter can include a camera intrinsic matrix K and a distortion coefficient dist. For any corner point on the calibration device, the board coordinates P_{board} of the corner point are transformed to the calibration device TCP coordinate system using the second transformation matrix T2: P_{B_TCP}=T2×P_{board}, and the first relative pose X

$$( i . e . , {T}_{C \_ TCP}^{b \_ TCP} )$$

to be solved is used to transform it to the camera TCP coordinate system: P_{C_TCP}=X×P_{B_TCP}. The TCP coordinates of the calibration device are transformed to the camera TCP coordinate system using the inverse matrix T1⁻¹ of the known first transformation matrix T1: P_{cam}=T1⁻¹×P_{C_TCP}. The 3D camera coordinates are projected onto the 2D pixel plane using the camera intrinsic matrix K: pₚᵣₒⱼ=K×P_{cam}, where P_{cam} is the normalized camera coordinates. Then, a re-projection error function is constructed based on pₚᵣₒⱼ and pₚᵢₓₑₗ, and the first relative pose X

$$( i . e . , {T}_{C \_ TCP}^{b \_ TCP} )$$

is calculated.

For example, obtaining the first transformation matrix from the image acquisition device to its first tool center point and the optical correction parameter of the image acquisition device includes: controlling the second robot to move to a first position to keep the calibration device fixed; controlling the first robot to move to a plurality of different first preset poses, and controlling the image acquisition device to acquire, in the different first preset poses, first images of the calibration device, respectively; and obtaining the first transformation matrix and the optical correction parameter based on the first images for the different first preset poses.

For example, obtaining the second transformation matrix from the calibration device to its second tool center point includes: controlling the first robot to move to a second position to keep the image acquisition device fixed; controlling the second robot to move to a plurality of different second preset poses, and controlling the image acquisition device to acquire second images of the calibration device in the different second preset poses, respectively; and obtaining the second transformation matrix based on the second images of the different second preset poses.

The calibration method provided in embodiments of the present disclosure can achieve the precise six-degree-of-freedom alignment of two robots, and the aligned dual-robot or multi-robot system can then be used to align two test antennas. This method is used to compensate for the deviation caused by the motion system or the system deformation caused by prolonged motion, either after the test antenna is installed or at maintenance cycle points. Before the calibration begins, the radar dome/radome is removed, the radio frequency (RF) antennas (assuming both the first and second testing devices are RF antennas) are removed from the two robot arms (i.e., the robot arms of the first robot and the second robot) and optical alignment devices (including the image acquisition device and the calibration device) are installed, respectively. For example, the calibration board/calibration device is installed on the inner robot arm (assuming the second robot is installed inside the radome), and the camera is installed on the outer robot arm (assuming the first robot is installed outside the radome).

For example, calibration steps include the following steps.

The first step is to move the inner robot arm to a fixed position (referred to as the first position for distinction), that is, the calibration board is fixed, control the outer robot arm to take pictures in multiple positions (i.e. the plurality of different first preset poses), realizing the eye-on-hand calibration, accurately calculate a TCP transformation matrix (i.e. the first transformation matrix T1) from the camera to the outer robot arm, and obtain the optical correction parameter of the camera.

In embodiments of the present disclosure, the optical correction parameter of the camera refers to an intrinsic parameter and a distortion coefficient of the camera, and these parameters are used to correct optical distortion caused by the camera lens and establish an accurate mapping between image pixel coordinates and three-dimensional (3D) world coordinates. The intrinsic parameter, such as the focal length, the principal point, and the tilt coefficient, describes the camera's optical characteristics and imaging geometry. The distortion coefficient, such as the radial distortion and the tangential distortion, is used to correct the distortion in the image caused by the lens shape. The optical correction parameter is obtained during camera calibration to improve the accuracy of visual measurements and ensure that feature points in the image can accurately correspond to their real-world locations.

For example, the calibration board (such as the Charuco board or checkerboard) is fixed at a certain position, and the outer robot arm (carrying the camera) is controlled to move to multiple different poses (i.e., different positions and orientations, referred to as the first preset poses), and images (i.e., “first images”) of the calibration board are captured from different angles. For example, first images of at least three non-coplanar poses are acquired; for example, 10-15 or more first images can be acquired to cover the entire field of view, and the calibration board is presented in various tilt and rotation states in the first images to ensure the robustness of the calibration. For each first image, an image processing algorithm (such as the PnP algorithm) is used to calculate the transformation from the calibration board to the camera coordinate system. In addition, the transformation from the outer robot TCP to the base coordinate system is recorded. The first transformation matrix from the camera coordinate system to the outer robot TCP coordinate system is determined according to the hand-eye calibration equation.

For example, the feature point (such as the corner point) on the calibration board is detected. For the Charuco board, both the checkerboard corner point and the ArUco-marked corner point are detected. The image coordinates (pixel coordinates) and corresponding world coordinates (based on the known physical size of the calibration board) of these feature points are recorded. The feature point data from all the first images is used, and the optimization calculation is performed using a camera calibration algorithm. The camera optical correction parameter is estimated by minimizing the re-projection error (i.e., the difference between the projected point and the actual detection point).

The second step is to move the outer robot (i.e., the first robot) to a fixed position (referred as to the second position for distinction, the first and second positions can be the same or different), i.e., the camera is fixed, control the inner robot arm to move to multiple positions (i.e., the second preset poses) to be captured by the first robot to obtain multiple second images, realizing eye-to-hand calibration, and accurately obtain the TCP transformation matrix (i.e., the second transformation matrix T2) from the calibration board to the inner robot arm.

Specifically, the second images are obtained under multiple different poses. For each pose, the transformation from the calibration board to the camera coordinate system is calculated using the PnP algorithm, while the transformation from the inner robot TCP to the base coordinate system is recorded. Then, the second transformation matrix is obtained according to the calibration equation. The base coordinate system refers to a fixed reference coordinate system of each robot itself, which can be located at the geometric center of the robot base.

The radar antenna and the test antenna can be precisely aligned with the mounting bracket through mechanical planes and positioning features, while the optical system (including the camera and the calibration board) and the mounting bracket (including the first mounting bracket and the second mounting bracket) are aligned through the first and second steps mentioned above.

It should be noted that there is no order between the first and second steps mentioned above, and the first step can be performed first or the second step can be performed first.

In the third step, the inner and outer robots are controlled, based on the predetermined detection points in the existing motion trajectories, to move to the corresponding predetermined detection points, the camera and the calibration board are used, and the relative pose (e.g., the first relative pose, the second relative pose, etc.) of the calibration board in the camera coordinate system is calculated. The inner robot (i.e., the second robot) or the outer robot is controlled to make small movements through the inverse matrix of the corresponding relative pose. Through multiple rounds of small adjustments, the alignment result is made less than a threshold, i.e., the origin deviation between the image acquisition device and the calibration device is less than the predetermined threshold, and the axis angle deviation (including the angle deviations between the axes of the image acquisition device and the calibration device and the normal line of the corresponding predetermined detection point, and the angle between the first horizontal axis of the image acquisition device and the first horizontal axis of the calibration device) is less than the first angle threshold and the second angle threshold, the current corrected positions (i.e., the corresponding corrected poses) of the inner and outer robots are recorded, and then the robots move to the next measurement point/predetermined detection point, such as the second predetermined detection point mentioned above.

For example, an outer surface of the radar dome/radome is a low-curvature convex surface. When the predetermined detection point is planned, the normal direction (Z-axis direction) is determined at each predetermined detection point through plane fitting. During the calibration, when the inner and outer robots carrying the camera and the calibration board move to the corrected detection positions, such that the angles between the axes of the camera and the calibration board and the normal line of the curved surface of the radar dome/radome are less than 0.1 degrees, the X-axis angle between the camera and the calibration board is less than 0.2 degrees, and the deviation between the origins of the camera and the calibration board in the X-Y plane is less than 0.5 mm, it is considered that the camera and the calibration board are precisely aligned in this case.

Specifically, for each predetermined detection point, the actual pose (including the first relative pose and the second relative pose, etc.) of the inner robot TCP relative to the outer robot TCP is calculated. The actual pose is compared with the ideal pose, so as to obtain the current translational and rotational deviations. For example, a Proportional-Integral-Derivative (PID) control strategy can be used to adjust the pose of the first or second robot, but the present disclosure is not limited to this.

For example, the motion trajectories of the first and second robots can be adjusted according to all the corrected positions/corrected poses to achieve the measurement alignment of the test antennas at each predetermined detection point.

For example, during the testing process, when the inner and outer robots carry two test antennas to the corrected detection position, such that the angles between the axes of the two test antennas and the normal of the curved surface of the radar dome/radome are less than 0.1 degrees, the X-axis angle between the two test antennas is less than 0.2 degrees, and the deviation between the origins of the two test antennas in the X-Y plane is less than 0.5 mm, it is considered that the two test antennas are precisely aligned.

In embodiments of the present disclosure, the first and second preset poses are pre-set to ensure the systematic and comprehensive nature of data acquisition, avoid deviations caused by subjective position selection, and ensure that the relative distance between the calibration board and the camera is relatively short and that there are multiple rotation angles to observe the calibration board from different perspectives, covering as many rotational degrees of freedom (pitch, yaw, roll) as possible. For example, 20 first preset poses are set in the first step, and 20 second preset poses are set in the second step, providing sufficient data to ensure calibration accuracy.

For example, the calibration device includes a checkerboard-and-coded-marker hybrid calibration pattern, that is, the calibration device can employ the Charuco board.

In embodiments of the present disclosure, when the calibration device uses the Charuco board, hand-eye calibration based on the Charuco board can be performed. Hand-eye calibration based on the Charuco board is used to accurately determine a spatial transformation relationship between the camera coordinate system and the robot end effector (tool) coordinate system (TCP). The Charuco board provides sub-pixel level corner point detection accuracy, in combination with the robustness of ArUco markers and the high-precision corner point of the checkerboard, effective calibration can still be performed even if some markers are obscured. The entire process can be fully automated, and the calibration results are stable and reliable, making it suitable for industrial applications. The calibration method provided in embodiments of the present disclosure of the disclosure can be implemented using an optical system equipped with the Charuco board.

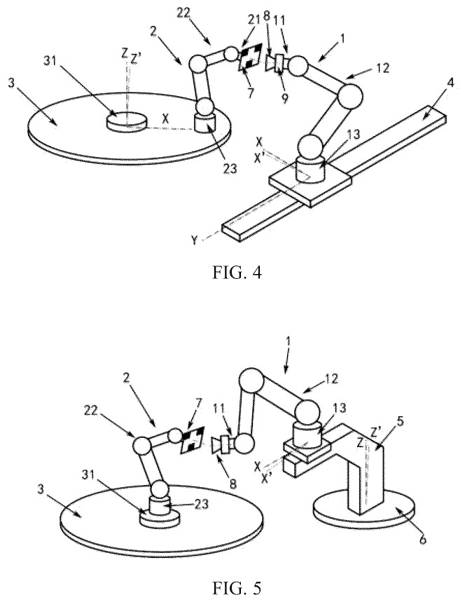

For example, as shown in FIGS. 4 and 5, the calibration device 7 includes a calibration board pattern and a disk. The calibration board pattern is drawn on the disk, which i mounted on the final axis or end 21 of a 6-axis collaborative robot (the second robot 2). An image acquisition device (e.g., a camera) 8 is installed on the final axis or end 11 of another collaborative robot (the first robot 1) to image the calibration board pattern. For example, the calibration device 7 and the image acquisition device 8 constitute an optical target system equipped with the Charuco calibration board. Charuco is a calibration board that integrates the checkerboard and the ArUco marker and is used for high-precision camera calibration and pose estimation.

For example, the end of the first robot includes a first mounting bracket, the end of the second robot includes a second mounting bracket, and installing the image acquisition device at the end of the first robot and the calibration device at the end of the second robot includes: removing a radome between the first robot and the second robot; and installing the image acquisition device on the first mounting bracket via a first fixed adapter, and the calibration device on the second mounting bracket via a second fixed adapter.

For example, the camera and the calibration board are respectively fixed to the mounting brackets of the corresponding horn antennas via the first fixed adapter and the second fixed adapter to ensure alignment between the optical device and the horn antenna. In embodiments of the present disclosure, the reference uniformity between the RF measurement system and the optical alignment system is ensured through a precise mechanical interface, thereby achieving high-precision, repeatable alignment. One end of the first and second fixed adapters has a mounting interface (i.e., an interface that mates with a positioning post) identical to that of the horn antenna, while the other end is used to mount the camera or the calibration board. The pose of the optical center of the first and second fixed adapters and the pose of the phase center of the horn antenna are precisely calibrated and set. When the first and second fixed adapters are installed in place, the position and orientation of the camera or the calibration board in space have a known and fixed transformation relationship with the position and orientation of the horn antenna during installation, making the entire alignment and testing process efficient and reliable.

In embodiments of the present disclosure, when the radome is tested, the first testing device can be installed on the first mounting bracket on the first robot, and the second testing device can be installed on the second mounting bracket on the second robot. During calibration, the image acquisition device is installed at the end of the first robot via the same first mounting bracket, and the calibration device is installed at the end of the second robot via the same second mounting bracket. Therefore, after the TCP alignment of the first and second robots is achieved through the image acquisition device and the calibration device, automatic alignment of the first and second testing devices can be automatically achieved during testing.

Embodiments of the present disclosure provide a novel method for precise alignment of the dual-robot tool center point (TCP), optimizing the alignment accuracy of the collaborative working of a pair of robots or collaborative robots, which requires high accuracy in both translational (position) and rotational (orientation) coordinate systems. Simultaneously considering three translational degrees of freedom and three rotational degrees of freedom, high alignment accuracy is achieved in the six degrees of freedom (6DoF). The relative pose between the camera and the calibration board is determined based on calibration images (including the first calibration image and the second calibration image) of the calibration board captured by the camera. The relative pose is compared with the ideal or expected pose to obtain an alignment error (including translational and/or rotational deviations), thereby obtaining the corrected pose/correction amount for each predetermined position (referring to all key points the robot needs to reach during calibration, corresponding to predetermined detection points) within the working range of the two robots. The predetermined poses (including the aforementioned first and second predetermined poses) in the motion trajectory are corrected through the corrected poses, and the optimal spatial pose for each robot axis is determined, including optimization for translation and rotation.

The calibration method provided in embodiments of the present disclosure solves the alignment problem in six-dimensional space, and optimizes the alignment of a pair of robots or collaborative robots that work together with high precision in rotational and translational coordinate systems. Three lateral axes and three rotational axes are simultaneously considered, where the three lateral axes refer to forward/backward, left/right, and up/down movement (X, Y, Z) in three-dimensional space. The three rotational axes refer to rotation (yaw, pitch, roll) around these three directions X, Y, and Z. The ends of the two robots are aligned not only in position but also in orientation, requiring precise control in a total of six dimensions. Any minute deviation will lead to measurement errors. In the test system, when the ends of the first and second robots are both mounted with radar horn antennas as the first and second testing devices, the above calibration ensures that the beam is perfectly perpendicular to the predetermined detection point on the radome.

For example, the robot TCP is the origin of a coordinate system relative to the end (sixth axis or flange) of the robot. When no physical tool is installed on the robot, the center point (i.e., the rotation center of the sixth axis) of the flange at the end of the robot can be defined as a default TCP, which is the geometric endpoint of the robot arm body. When a tool is installed at the end of the robot, an effective working point of this tool is defined as the new TCP. When the robot controls the new TCP to move in space, a distance from the robot TCP to the new TCP is automatically calculated and compensated.

For example, obtaining the motion trajectories of the first robot and the second robot includes: obtaining a three-dimensional model of the radome; planning a scanning path of the radome according to the three-dimensional model, and determining the N predetermined detection points on the scanning path and a normal direction at each predetermined detection point; and generating, according to the normal direction and a set measurement distance between a first testing device and a second testing device, arrival poses of a first tool center point of the first robot and a second tool center point of the second robot to generate the motion trajectories.

In embodiments of the present disclosure, a test system is provided for testing the performance of the radome. The test system is implemented using the first testing device installed on the first robot and the second testing device installed on the second robot. In this scenario, the motion trajectories of the first and second robots can be planned and generated based on the 3D model of the radome, so that when the first and second robots reach the predetermined poses according to the motion trajectories, the N predetermined detection points on the preset scanning path of the radome can be accurately detected, for example, a constant measurement distance is maintained between the first and second testing devices, and the line connecting the axes of the first and second testing devices is parallel to the normal direction at each predetermined detection point.

For example, a radome/radar dome test rig is provided, on which the first robot and the second robot operate. Through calibration, the orientation and normal of the first TCP of the first robot and the second TCP of the second robot are perfectly matched, so that when the radome is tested, the precise alignment of the polarized radar signal beams of the first testing device and the second testing device is ensured.

For example, during calibration, the camera captures the calibration board pattern, any lateral or rotational offset is registered as a misalignment by the camera and the correction is calculated accordingly. Subsequently, two collaborative robots move to each predetermined position (corresponding to the predetermined detection point) within their working ranges, and image data (including the first and second calibration images) for all positions is recorded. The image data is used to determine the optimal spatial pose (i.e., the optimal rotation and translation state) of each robot axis, thereby achieving optimal alignment of the first testing device (e.g., a radar horn antenna) and the second testing device (e.g., another radar horn antenna) in the radome testing scenario.

Through the calibration method provided in embodiments of the present disclosure, on the one hand, the equipped high-quality optical camera is enabled to capture extremely small perpendicularity (normal) deviations through the special feature pattern (such as the Charuco calibration board) on the alignment disk/calibration device, resulting in high-precision optical alignment performance. The system can simultaneously calibrate the final axis of the robot in both translational (lateral) and rotational (orientation) dimensions, providing multi-dimensional calibration capabilities. In addition, the use of a small-diameter alignment disk (e.g., 100 mm) significantly reduces the risk of collisions during the movement of two or more robots, resulting in enhanced safety.

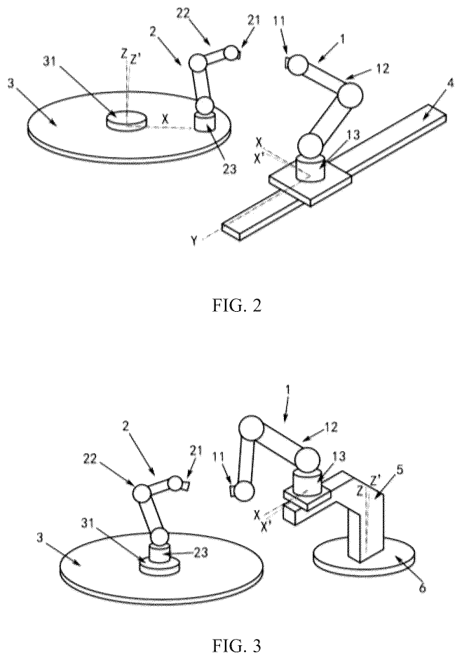

As shown in FIG. 2, a dual-robot system includes a first robot 1 and a second robot 2. The first robot 1 includes an end 11, a first robot arm 12, and a first base 13, which is attached to a motion mechanism, i.e., a linear track 4. The second robot 2 includes an end 21, a second robot arm 22, and a second base 23, which is attached to a second turntable 3 with a turntable center 31.

FIG. 3 illustrates another dual-robot system, which differs from the embodiment in FIG. 2 in that the first base 13 of the first robot 1 is installed on a first turntable 6 via an L-shaped bracket 5, and the second base 23 of the second robot 2 is installed on the turntable center 31 of the second turntable 3.

In FIGS. 2 and 3, x and z respectively represent one axis in the ideal xyz directions of the robot, while x′ and z′ represent axes with actual small-angle deflections. When the robot's fixed point is far away or unstable, errors are introduced into the robot's base coordinates. When there are two robots installed at distant locations in the system, or when any robot is attached to an additional motion mechanism (the turntable or the linear track), the two robots need to cooperate during operation. In this case, if the robot base coordinate calibration is subject to the calibration deviation (or insufficient calibration accuracy), or if the base flange deforms during the robot motion, the deviation is introduced to the robot's end tool center point (TCP) motion or positioning.

For example, in a scenario of testing the radome/radar dome, the system uses two robots, where the smaller robot (the inner robot of the radome, i.e., the second robot 2) is located at the turntable center 31 of the second turntable 3, while the larger robot (the outer robot of the radome, i.e., the first robot 1) is fixed to the second turntable 6 via an L-shaped bracket 5. The entire system must simultaneously control both turntables (i.e., the first turntable 6 and the second turntable 3). The two robots, with a total of 14 axes, ensure that the two measurement/test antennas in the first and second testing devices reach their respective detection positions to detect the corresponding predetermined detection points. In the system, since the bracket (i.e., the L-shaped bracket 5) of the outer robot (the first robot 1) is fixed to the second turntable 6, and the bracket arm is relatively long (the length of the moment arm from pivot to pivot is approximately 1.5 meters), there is a deviation in the path points of the outer robot.

The aforementioned 14 axes include 6 joint axes of the first robot (base rotation, shoulder swing, elbow extension, wrist rotation, etc.), 6 joint axes of the second robot, one rotation axis of the first turntable for driving the first robot fixed on it and its L-shaped bracket to rotate as a whole, and one rotation axis of the second turntable for driving the second robot placed at its turntable center.

FIGS. 2 and 3 illustrate common situations which may cause the robot base to twist. Both FIGS. 2 and 3 show instability. In FIG. 2, the robot is fixed to the turntable or linear track, causing deflection. In FIG. 3, the outer robot arm (i.e., the first robot arm) is fixed to the turntable and the L-shaped bracket.

Embodiments of the present disclosure use the optical method to compensate for the TCP deviation introduced by the above two types of problems.

For example, as shown in FIGS. 4 and 5, based on FIGS. 2 and 3 respectively, during system calibration, an optical calibration disk (i.e., the calibration device 7) is installed at the end 22 of the inner robot (the second robot 2), and the image acquisition device (e.g., the camera) 8 is installed at the end 11 of the outer robot (the first robot 1). By calibrating and compensating for the deviation of the path points of the outer robot, the transmission main lobe direction/polarization direction axes of the two microwave antennas (test antennas) in the first and second testing devices are aligned, and a distance between the two test antennas is compensated.

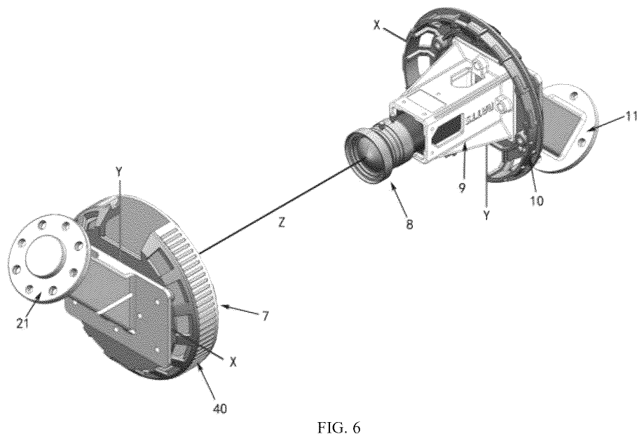

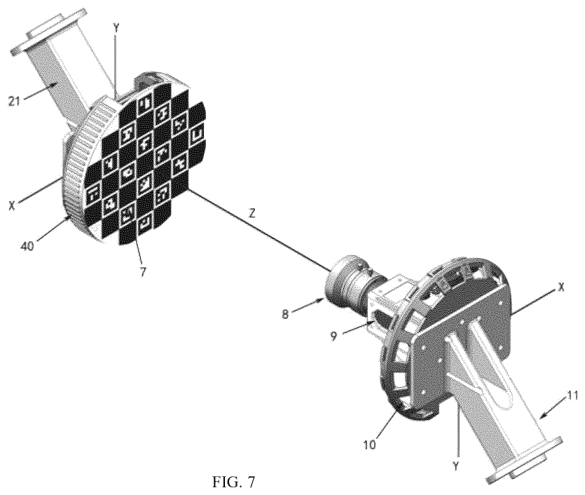

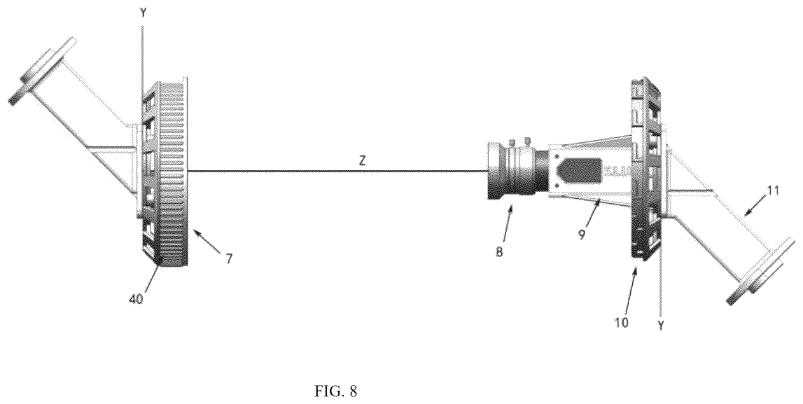

FIGS. 6, 7, and 8 show the aligned image acquisition device 8 and calibration device 7 observed from different perspectives. FIGS. 6, 7, and 8 illustrate the alignment process at a single detection point after the optical systems are installed on the antenna mounting brackets using their respective fixed adapters. After alignment, in the ideal situation, the Z-axis of the calibration device 7 and the Z-axis of the image acquisition device 8 coincide and are opposite in direction, so do the Y-axis and the X-axis. In practice, slight errors are permissible.

As shown in FIG. 7, the front of the calibration device 7 includes a Charuco calibration pattern, which combines the checkerboard and the ArUco codes. The checkerboard provides high-precision corner points for positioning, while the ArUco codes provide a unique ID for identification, ensuring stable operation even when the pattern is partially obscured.

As shown in FIGS. 6 to 8, the image acquisition device 8 is installed at the end 11 of the first robot 1, and the calibration device 7 is installed at the end 21 of the second robot 2. The image acquisition device 8 and the calibration device 7 are precisely installed so that they are in the same orientation and position as the vertical direction of the two radar horns in the first and second testing devices installed on the two collaborative robots during the test. That is, the relative position of the image acquisition device 8 and the calibration device 7 is exactly the same as the relative position of the two radar horn antennas in the first and second testing devices. In this way, through calibration, the image acquisition device 8 is aligned with the calibration device 7, and the two radar horn antennas are also aligned during the test.

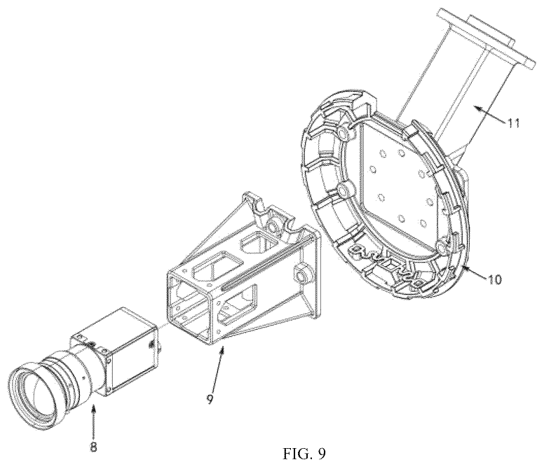

As shown in FIG. 9, the image acquisition device 8 can be installed, via a camera bracket 9, to a shielding cover base 10 of the first testing device and the flange at the end 11 of the first robot 1.

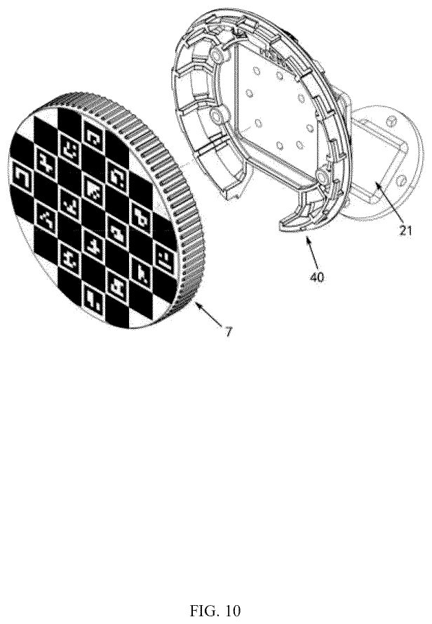

As shown in FIG. 10, the calibration device 7 can be installed to a shielding cover base 40 of the second testing device and the flange at the end 21 of the second robot 2.

It should be noted that the calibration device 7 can be installed in various ways. For example, the calibration device 7 can be directly installed on the microwave antenna bracket used to install the second testing device, or can be directly installed on the TCP of the second robot 2, or can replace the existing tool head (such as the first testing device or the second testing device) through a tool changer (a tool quick change device or automatic tool exchange system).

The method and system provided in embodiments of the present disclosure improve the traditional alignment method that relies on the “external testing device” such as the laser tracker. The advantage of the calibration method in the embodiments of the present disclosure is that it directly aligns the robot. Therefore, the system and method provided in the embodiments of the present disclosure have stronger self-calibration capabilities because they directly measure the characteristic under test. The sensors used (the camera and the alignment disk) are not part of the measurement system, thus providing an independent alignment means for the final axis of the robot or collaborative robot. Furthermore, the process is fully automated and requires virtually no human intervention.

In the related arts, a method for testing the transmissivity of the radar dome/radome component involves the use of either a long throw lab (test distance is required to be 100 meters) with a weather radar as a detector or a smaller footprint piece of equipment with the weather radar as the source and detectors in an ark array. Testing at labs can be rather expensive, time consuming and of debatable veracity, especially given the variation in testing types. The cost of purchasing the radome test machines is very high as they make use of actual avionic weather radars as the signal source and must be enclosed in a microwave safe electromagnetic shielded chamber.

The radome assessment and transmission test system provided in embodiments of the present disclosure develops a small-footprint testing device that uses a low power signal source, with a potential retail price around one tenth of that of an existing system but with comparable accuracy.

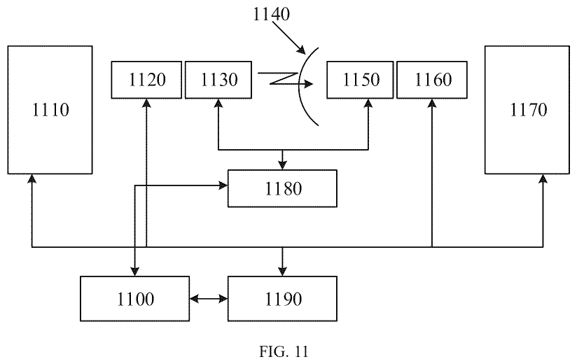

As shown in FIG. 11, embodiments of the present disclosure further provide a radome test system. The radome test system includes a data processing terminal 1100, a fixture positioner 1110, a first testing device positioner (which can be used to position the antenna, and is therefore also called the first antenna positioner or antenna positioner 1) 1120, a first testing device 1130 (which includes horn antenna 1), a radome 1140, a second testing device 1150 (which includes horn antenna 2), a second testing device positioner (which can be used to position the antenna, and is therefore also called the second antenna positioner or antenna positioner 2) 1160, a radome positioner 1170, a transceiver (including an emitter and a receiver) 1180, and positioner control equipment 1190.

For example, the radome may include: a skin, which is the main material layer constituting the radome body, and can be made of a material with the low dielectric constant and the low loss tangent, such as the Fiberglass Reinforced Plastic (FRP), the ceramic, the composite material, or the special engineering plastic; a sandwich structure, which, for the radome requiring high strength (such as the nose-mounted radome of the aircraft), can be a solid-core sandwich structure or a honeycomb-core sandwich structure. This structure achieves lightweighting while ensuring rigidity and strength, and its electromagnetic properties are carefully designed to optimize the transmissivity. For example, the radome may also include a rain erosion-resistant/anti-static coating. For example, the radome may include a metal frame/mounting base, and the radome is connected and fixed to the aircraft airframe or robot structure via the metal frame. For example, when operating normally, the radome can be installed on the nose cone of a commercial aircraft. The radar dome/radome is located at the very front of the nose and a weather radar antenna array is installed inside.

For example, the method provided in embodiments of the present disclosure includes: installing the radome on a rotation device; and rotating the radome by the rotation device, and detecting transmissivity of predetermined detection points in different areas of the radome using the first testing device and the second testing device.

For example, to test the radome as a whole, several sub-products are designed, manufactured, and assembled to form the final test rig. After the radome is loaded onto the test rig, it is placed on four mounting points for precise positioning. Each mounting point is physically connected to a rotary driver. That is, the radome is positioned on a rotating turntable, with the center of the radome aligned with the central axis of the rotating turntable. This allows the radome to rotate, so that all inspection devices (radar near-field testing and active thermal imaging) can access the entire radome surface.

For example, the radome test system also includes a fixture for precisely clamping and securing the radome 1140. Since the proposed solution is targeted to be utilized by the MRO factory which undertakes the maintenance work for various radome models, the fixture should be adaptive to different types of radome.

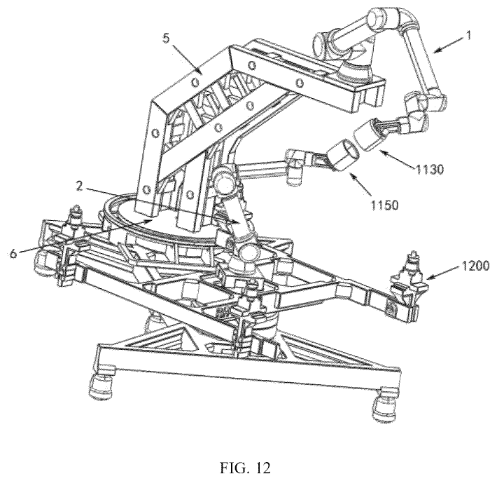

In embodiments of the present disclosure, the fixture positioner 1110 is a mechanism that enables the fixture to perform single-axis or multi-axis rotation/tilt motion to change its spatial angle. It is a rotatable display platform that drives the fixed radome 1140 to rotate, orients different areas of the radome toward the test antenna, so as to accurately detect predetermined detection points on different areas of the radome. For example, this can be achieved using a rotation device 1200 in FIG. 12, thereby expanding the workspace and accessibility of the first and second robots, allowing them to cover different areas of the radome without having to move a long robot arm.

Embodiments of the present disclosure can simplify the motion trajectories of the first and second robots by rotating the radome body using the rotation device, so that the robot only needs to move within a single fan-shaped area without having to go around to the other side of the radome, to cover the entire radome surface in combination with the rotation of the rotation device, reducing the robot's movement range, improving speed and accuracy, and lowering programming complexity. Furthermore, the more precise control for the pose of the radome 1140 can be allowed through the radome positioner 1170.

The first testing device positioner 1120 can be used to precisely control and change the spatial orientation (the azimuth angle and the elevation angle) of the horn antenna 1, for example, by means of the first robot 1.

The second testing device positioner 1160 can be used to precisely control and change the spatial orientation (the azimuth angle and the elevation angle) of the horn antenna 2, for example, by means of the second robot 2.

For example, the transceiver 1180 may include a Vector Network Analyzer (VNA). The transceiver 1180 emits a test signal, which is a radio frequency (RF) signal, to first testing device 1300. This test signal passes through the radome 1140, and is then received by the second testing device 1150, and returns to the transceiver 1180. The transceiver 1180 sends the received data to the data processing terminal 1100. The data processing terminal 1100 processes the data, for example, to obtain the transmissivity of the radome, etc. The data processing terminal 1100 may also send a control signal to the positioner control equipment 1190 based on the data processing result. The positioner control equipment 1190 may send control signals to the fixture positioner 1110, the radome positioner 1170, the first testing device positioner 1120, and the second testing device positioner 1160, respectively, to control the poses of the fixture, the radome, the horn antenna 1, and the horn antenna 2.

For example, the data processing terminal 1100 and the positioner control equipment 1190 can be separate physical hardware or integrated into the same physical hardware, such as both being part of a controller.

FIG. 11 is a schematic diagram of the system structure of a radio frequency part of the radome test system, which can be divided into two main parts: a motion control module that controls the overall mechanical movement of the system, and a signal processing section that controls signal emitting and data post-processing. The entire system can be driven by the data processing terminal 1100. The motion control module is responsible for all physical movement and precisely positions the first testing device 1130 and the second testing device 1150. The motion control module includes the positioner control equipment 1190, and can be a dedicated computer, which receives high-level instructions (e.g., “move to coordinates X, Y, Z”) from the data processing terminal 1100 and converts these instructions into precise electrical signals to drive the motion of the fixture positioner 1110, the radome positioner 1170, the first testing device positioner 1120, and the second testing device positioner 1160, thereby driving the motion of the robot arms of the first and second robots and any other potential positioning mechanisms (such as the linear guide). The robot arms of the first and second robots are respectively equipped with the horn antenna 1 and the horn antenna 2, responsible for performing specific movement tasks.

For example, the data processing terminal 1100 issues an instruction of “go to point A for measurement”. The positioner control equipment 1190 calculates the rotation amount of each joint of the first and second robots required to reach point A. The positioner control equipment 1190 drives the robot arms of the first and second robots to precisely move the horn antenna 1 and the horn antenna 2 to the predetermined positions to measure point A of the radome, and ensures correct orientation (the line connecting the axes of horn antenna 1 and horn antenna 2 is perpendicular to the radome wall). The positioner control equipment 1190 feeds back to the data processing terminal 1100: “in position”. The data processing terminal 1100 controls the transceiver 1180 to generate, emit, and receive the radio frequency test signal to complete the measurement.

For example, the transceiver 1180 generates a radio frequency signal of 9.375 GHz, which is transmitted via a cable to the emitting horn antenna 1. The horn antenna 2 receives the signal passing through the radar dome/radome from horn antenna 1 and transmits it back to the VNA via another cable. The inside circuitry of the VNA can accurately compare the amplitude (intensity) and phase (time delay) of the emitted and received test signals. The transceiver 1180 can calculate all the information of the transmissivity (from amplitude) and the phase offset (from phase) of the measurement point/predetermined detection point based on the comparison results. For example, the data processing terminal 110 can store or run a path planning algorithm to determine a scanned grid point sequence, i.e., determine the scanning path of the radome and the predetermined detection points on it, and generate the corresponding motion trajectories of the first and second robots.

For example, the data processing terminal 1110 can also receive data returned by the VAN, such as the transmissivity of each predetermined detection point, and store the received data together with the spatial coordinates of the predetermined detection point.

For example, the data processing terminal 1110 can also perform near-field data to far-field data transformation, such as transform near-field data into far-field data.

For example, the data processing terminal 1110 can also run a weighted average to synthesize the acquired thousands of near-field data points into a far-field performance indicator (such as far-field transmissivity) that simulates a real antenna.

For example, the data processing terminal 1110 can also generate a color heat map of transmissivity, etc.

For example, the data processing terminal 1110 can also provide an operator with a graphical interface for starting tests, monitoring progress, and viewing results. For example, the operator clicks “Start Test” on the software of the data processing terminal 1110. The data processing terminal 1110 commands the motion control module to move horn antenna 1 and horn antenna 2 to poses corresponding to a first measurement point. After positioning, the data processing terminal commands the VNA to perform measurements and acquire data. The data processing terminal saves the measured data along with the current spatial coordinates. The above measurement steps are repeated until all grid points have been scanned. After scanning is completed, the data processing terminal 1110 automatically executes the post-processing algorithm to generate the final assessment report and visualization graphs. Embodiments of the present disclosure achieve modularity of the automated test system by clearly separating the motion control and the signal processing into two major modules, and unifying the driving architecture by a central data processing terminal, facilitating development and maintenance. The mechanical motion and the signal acquisition are perfectly coordinated and highly synchronized. The process is fully automated, requiring no manual intervention. The central control ensures the process consistency and the data integrity.

For example, the method provided in embodiments of the present disclosure includes: removing the image acquisition device from the first mounting bracket and the calibration device from the second mounting bracket; installing a first testing device on the first mounting bracket and a second testing device on the second mounting bracket; and moving the first robot and the second robot according to the motion trajectories and the corrected pose to align the first testing device and the second testing device at the predetermined detection point, and detecting the radome at the N predetermined detection points by the first testing device and the second testing device.

In embodiments of the present disclosure, the installation of the calibration board and the camera is precisely designed to ensure that they are in the exact same normal position and orientation relative to the horn antennas installed on their respective collaborative robots. After calibration, the radar waves can be perpendicularly incident on the surface of the radar dome/radome (normal), thus achieving precise alignment of the polarized radar signal beam.

In embodiments of the present disclosure, the dual-robot tool center point alignment method based on the Charuco pattern can achieve sub-pixel level alignment accuracy, reaching sub-millimeter and sub-arcsecond levels alignment accuracy, meeting the stringent requirements of radio frequency testing. Compared to the laser tracker that costs hundreds of thousands of dollars, an industrial camera and a printed Charuco board are extremely inexpensive. Embodiments of the present disclosure solve the high-cost, high-precision industrial robot calibration problem with a low-cost, highly intelligent vision solution. It simulates and replaces the alignment requirements of horn antennas, transferring the precision of optical alignment to radio frequency alignment through the precision mechanical installation. The entire process can be completed automatically by the software, requiring no professional personnel, and can be executed quickly before each test, ensuring the system is always in optimal condition and achieving routine high-precision calibration. A “deviation-compensation” database of thousands of points is established throughout the workspace of the robot. Subsequently, when the robot performs radome testing, the control system queries this database and automatically compensates for each predetermined pose, thereby achieving continuous high-precision alignment in actual operation.

For example, the method provided in embodiments of the present disclosure includes: when the radome is not installed between the first robot and the second robot, collecting a first signal power of a test signal at the predetermined detection point by the aligned first testing device and second testing device; installing the radome between the first robot and the second robot, and collecting a second signal power of the test signal passing through the radome at the predetermined detection point by the aligned first testing device and second testing device; and obtaining transmissivity of the radome at the predetermined detection point according to the first signal power and the second signal power.

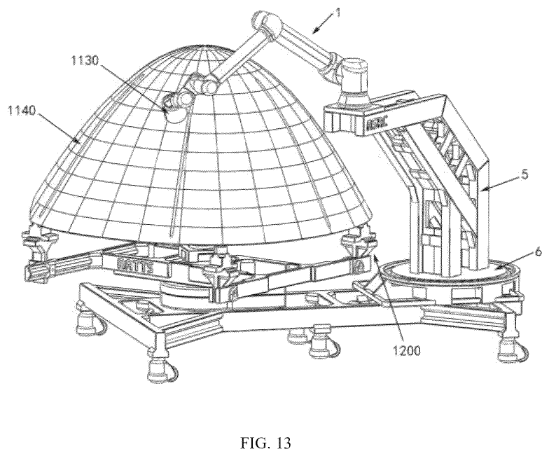

For example, as shown in FIG. 12, when there is no radome installed between the first robot 1 and the second robot 2, the first signal power is obtained through the first testing device 1130 and the second testing device 1150. As shown in FIG. 13, the radome is installed between the first robot 1 and the second robot 2, and the second signal power is obtained through the first testing device 1130 and the second testing device 1150.

In embodiments of the present disclosure, as shown in FIG. 12, the first signal power of the test signal is measured in free space (a reference measurement environment without the radar dome/radome). As shown in FIG. 13, after the radar dome/radome is installed, the measurement is repeated under the exact same position and conditions to obtain the second signal power of the test signal. Transmissivity=(Second signal power with radome/First signal power without radome)×100%.

For example, the test signal radiated by the VNA is fed to horn antenna 1 and horn antenna 2 via a high-quality coaxial cable (with low loss, excellent shielding, and stable phase characteristics). The radio frequency signal generated by the VNA is transmitted from port 1 to the emitting antenna (e.g., horn antenna 1), and the signal captured from the receiving antenna (e.g., horn antenna 2) is transmitted back to port 2 of the VNA. The VNA can generate a clean and frequency-tunable radio frequency signal as a test signal and can accurately measure the amplitude and phase of the input test signal. By comparing the emitted and received test signals, various characteristics of the radome under test can be analyzed.

For example, the cable is guided along the robot arm of the robot. In RF testing, a moving cable can generate phase noise and signal fluctuations due to bending and swaying. Securing the cable along the arm can minimize the change in cable shape, ensuring stable signal transmission and resulting in high-precision, repeatable data.

For example, the electromagnetic waves radiated by horn antenna 1 and horn antenna 2 are polarized light, and they have plano-convex focusing lenses in front of them to collimate the radiation as much as possible. Horn antennas themselves have a certain directionality, but their emitted beams still have a certain divergence angle. The role of the lenses is to further collimate the divergent beams into the nearly parallel beams.

For example, the lens is made of polymeric materials such as polytetrafluoroethylene (PTFE), and the horn antenna (referred to as the horn for short) is made of aluminum. At microwave frequencies, certain polymers such as PTFE have very low dielectric loss, resulting in minimal energy absorption as electromagnetic waves pass through. Aluminum is an ideal material for manufacturing microwave antennas because it is both a good conductor (ensuring efficient electromagnetic wave radiation) and lightweight and easy to process.

For example, the horn antenna is a waveguide antenna shaped like a horn. This structure can effectively convert electromagnetic waves propagating in the waveguide into directional beams propagating in free space, and vice versa.

For example, the horn antenna is a polarized horn antenna. That is, the electromagnetic waves emitted or received by the horn antenna have a specific polarization direction (e.g., linear polarization, such as vertical or horizontal polarization). Specifically, the emitting path is from VNA port 1 to a high-quality coaxial cable, then to the polarized horn antenna 1 (which converts the electrical signal into the electromagnetic wave), and then through a plano-convex lens to collimate the diverging electromagnetic wave into a narrow beam directed towards the radome under test. The receiving path is to converge the beam through a lens from the electromagnetic wave reflected or transmitted back from the radome, then convert the electromagnetic wave into an electrical signal through the horn antenna 2, and back to VNA port 2 via a high-quality coaxial cable.

In testing, the actual radar antenna on the aircraft is not operational, and may not even be inside the radome. Embodiments of the present disclosure use a standard horn antenna instead, because the performance of the horn antennas is known, stable, and repeatable. This ensures consistency and impartiality in testing: regardless of which radome is tested, the signal source and the receiver remain constant; only the radome itself changes, thus accurately assessing the radome's quality.

In embodiments of the present disclosure, through the calibration of the optical system described above, the test signal emitted by the horn antenna 1 can be incident perpendicularly or normally onto the radome during the radome test process. That is, the electromagnetic wave propagation direction is completely parallel/coincides with the normal direction of the test point (predetermined detection point) on the radome surface, and the beam is just perpendicularly emitting towards the radome surface.

In embodiments of the present disclosure, the first robot and the second robot are two collaborative robots. They are high-precision industrial robot arms programmed to work together safely and flexibly. The first and second robots move synchronously, maintaining the test signal incident normally to achieve the high-precision measurement. The ends of the first and second robots are respectively equipped with corresponding horn antennas and lenses, which move synchronously on the complex curved surface of the radar dome/radome, always ensuring that the beam is perpendicular to the surface of the point under test.

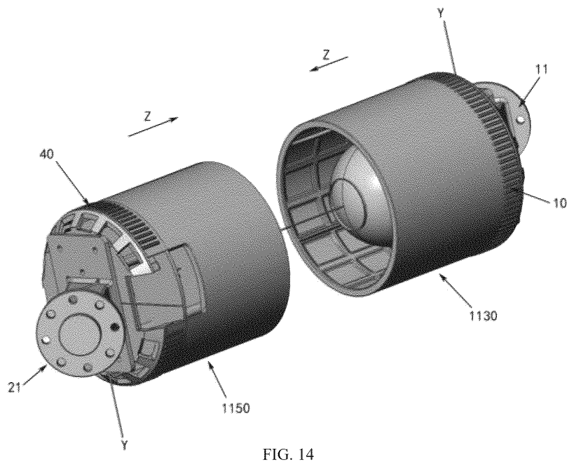

FIGS. 14, 15, 16 and 17 are schematic diagrams of the alignment of two test antennas.

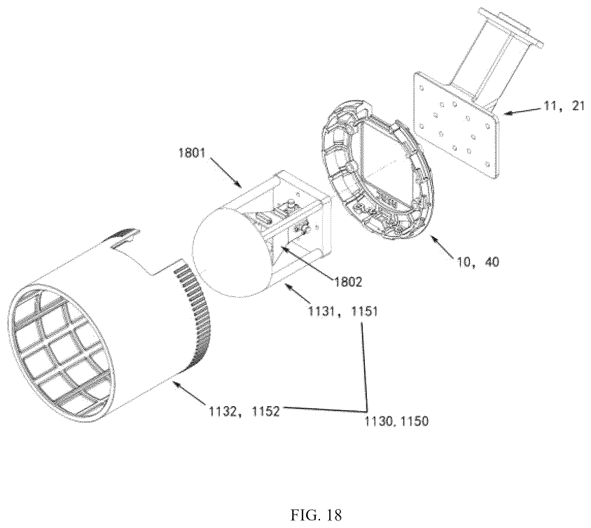

As shown in FIG. 18, the first testing device 1130 includes a shielding cover 1132, a horn antenna 1131 (e.g., horn antenna 1), and a shielding cover base 10. The rear of the shielding cover base 10 is fixed to the first robot TCP, and as shown, the shielding cover base 10 is fixed to the flange at the end 11 of the first robot 1. The second testing device 1150 includes a shielding cover 1152, a horn antenna 1151 (e.g., horn antenna 2), and a shielding cover base 40. The rear of the shielding cover base 40 is fixed to the second robot TCP, and as shown, the shielding cover base 40 is fixed to the flange at the end 21 of the second robot 2.

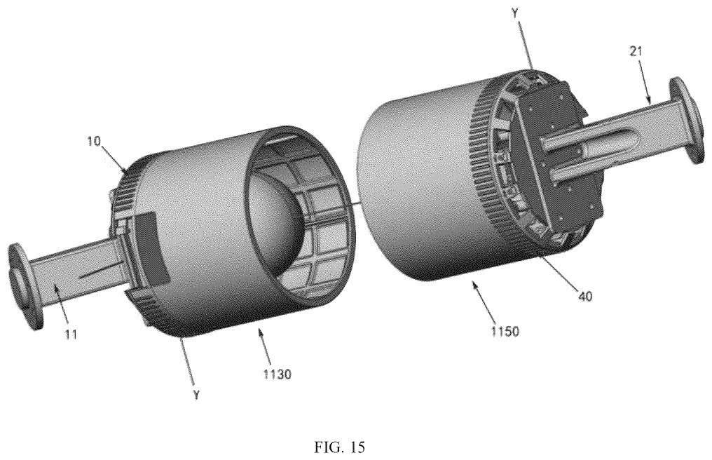

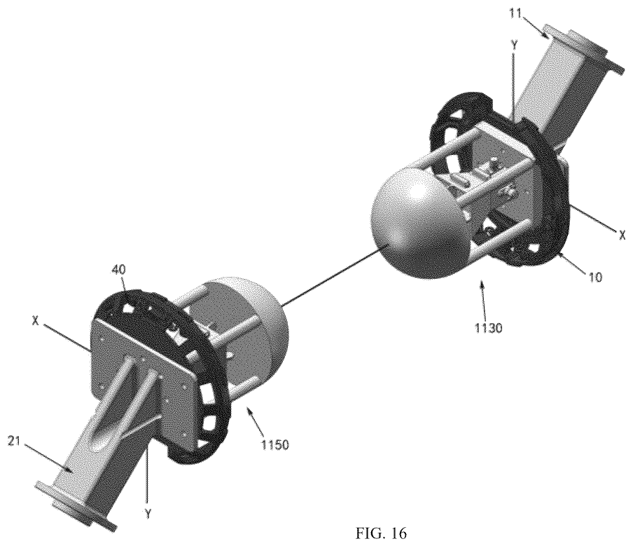

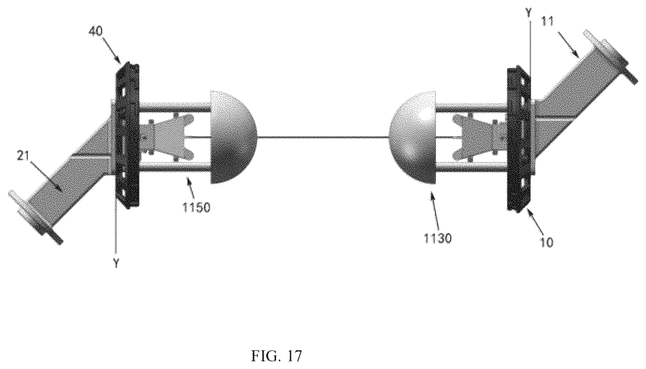

In FIGS. 14 and 15, the first testing device 1130 has the shielding cover 1132, and the second testing device 1150 has the shielding cover 1152. FIGS. 16 and 17 are schematic diagrams of the alignment of two horn antennas after the shielding covers have been removed.

In FIGS. 14, 15, 16, and 17, taking installing two horn antennas as an example, the primary microwave propagation direction is along the Z-axis direction, while the polarization direction of the horn antenna is along the Y-axis direction. The aligned origins of the two horn antennas are centers of their flanges. The calibration target is that the Z-axes of the two horn antennas coincide and are opposite in direction (transmit/receive directions); and the Y-axes of the two horn antennas coincide and are opposite in direction (same polarization).

Embodiments of the present disclosure provide a radome assessment and transmission test system and a novel method for dual-robot tool center point alignment. When two robot arms each hold a horn antenna, the TCP can be defined as the phase center of each horn antenna, i.e., a theoretical point from which electromagnetic waves appear to be emitted. This is the electrical center of the antenna radiation, not its physical center. Through the collaborative work of two independent robot arms, the TCPs of the two robots establish a precise, stable, and known spatial relationship in three-dimensional space. As shown in FIGS. 14 to 17, the alignment goal is to ensure that throughout the scanning process, regardless of changes in the surface curvature of the radome, the two horn antennas always satisfy the ideal test geometry relationship: collinear alignment, the line connecting the TCP of the emitting horn antenna and the TCP of the receiving horn antenna (the Z-axis shown in FIGS. 14 to 17) must always be perpendicular to the tangent plane of the radome's test point; distance alignment, the distance between the two TCPs must always remain constant, for example, 96 mm.

Embodiments of the present disclosure provide a novel method for precise TCP alignment of two robots, optimizing and simplifying the alignment process for robots or collaborative robots requiring high levels of cooperation. It ensures a high degree of parallelism and perpendicularity (normality) between the end effectors of the two robots within a large workspace. This requires precise control of six degrees of freedom (6DoF): three Cartesian translational degrees of freedom (XYZ) and three rotational degrees of freedom (i.e., pitch, yaw, and roll). In a specific application of the test rig provided in embodiments of the present disclosure, each of the two collaborative robots holds a polarized radar horn antenna on its sixth axis (final axis). Therefore, not only spatial position alignment is required, but also precise matching of the polarization direction (polarization axis, e.g., the Y-axis shown in FIGS. 14 to 17) and tilt angle (tilt axis, i.e., the Z-axis shown in FIGS. 14 to 17) of the two antennas should be ensured.

For example, a high-precision digital 3D model of the radome under test is obtained through the 3D laser scanning or photogrammetry. Based on this model, the scanning path is planned, and a 3D trajectory on the radome's curved surface is created. The robot arm has six rotational joints, giving it six degrees of freedom in 3D space: three degrees of freedom (X, Y, Z) for position control, and the other three degrees of freedom (roll, pitch, yaw) for orientation control. Therefore, not only the horn can be moved to a point but also its orientation can be adjusted. For each target point on the path, the normal direction (i.e., the perpendicular direction) of the radome surface at that point is calculated based on the 3D model. Then, the two robot arms are controlled so that the central axes of the emitting and receiving horns coincide with this normal. This ensures that the radio waves penetrate the radome wall through normal incidence, which is a standard and repeatable test condition. The system treats the emitting and receiving horns as a whole. They are not only synchronous in orientation but also move synchronously in position, always maintaining a preset fixed distance (e.g., 96 mm) between the emitting and receiving horns and the radome surface. In a maintenance and inspection scenario, the accuracy of measuring local material properties is far more important than simulating the global antenna pattern. Synchronous movement of both arms ensures normal incidence at every point, thus normalizing all measurements to the same standard and making the data comparable.

Specifically, this alignment goal can be achieved by combining offline programming and real-time control. In the offline planning phase, a precise digital model of the radome can be obtained through 3D scanning. For each point on the scanning path, the surface normal direction for this point is calculated. Then, based on this normal direction and a set constant measurement distance, the precise positions and orientations that the two robots' TCPs need to reach are calculated. This generates a synchronized motion trajectory. In the online execution and compensation phase, during the actual movement, due to minor positioning errors and gear backlash inherent in the robots themselves, simply executing the preset program is insufficient to achieve metrological accuracy. Therefore, the alignment or calibration process calibrates and verifies the actual TCP positions of the two robots, ensuring that the “theoretical position” calculated in the software is consistent with the “actual position reached” by the robot. Any minor deviation will be measured and compensated during the system calibration phase. Misalignment or inaccurate alignment will directly introduce measurement errors. If the beam is not incident normally but obliquely at an angle onto the radome, it will cause distortion in the transmissivity measurement (e.g., lower readings). It will be impossible to distinguish whether signal attenuation is caused by the poor material property or an incorrect measurement angle. If the distance between the two horns fluctuates during scanning, the antenna's radiation pattern will be altered, affecting the signal strength and phase, and causing inconsistencies and incomparability in measurement data from different points. Dual-robot tool center point alignment, through the precise robot control and calibration technology, creates and maintains an “idealized”, “unchanging” laboratory-grade testing environment on the complex 3D curved surface. This results in extremely high accuracy and repeatability of the measurement data. All data points are acquired under the same standard, allowing for fair comparison. This ensures the generation of accurate and reliable compliance reports.

Through this precise calibration and compensation, the dual-robot system can ensure measurement accuracy, with TCP alignment error <0.1 mm and angular error <0.1°; guarantees data consistency, ensuring all measurement points are obtained under identical geometric conditions; achieves true verticality, with the beam always normally incident on the radome surface; and maintains a constant measurement distance, such as precisely controlling the 96 mm test distance. This enables the near-field test system to produce results highly correlated with the far-field testing, providing the MRO industry with laboratory-level measurement capabilities while maintaining the convenience and economy of a workshop environment.

For example, the optical system includes a camera, a calibration board and its fixture adapter (referred to as the first fixed adapter and the second fixed adapter, respectively). For example, as shown in FIG. 18, assuming that the first testing device 1130 includes a horn antenna 1131, and the second testing device 1150 includes a horn antenna 1151. The horn antennas 1131 and 1151 have 45-degree mounting brackets 1802 and positioning posts 1801 on their respective corresponding robot TCPs to ensure repeatability accuracy of the horn antenna installation.

During the calibration phase, the horn antenna is removed. The first fixed adapter with the camera is installed onto the mounting bracket of the first robot. The second fixed adapter with the calibration board is installed onto the mounting bracket of the second robot. The previously described three-step optical alignment is performed. At this point, the system is actually simulating and calibrating the relative pose between the two horn antennas. During the testing phase (RF measurement), the first and second fixed adapters are removed. The horn antennas are reinstalled onto their respective mounting brackets. Due to the presence of the positioning posts and precise interfaces, the actual pose of the horn antenna at this point is highly consistent with the simulated pose during the optical alignment, so that the reference (phase center of the horn antenna) for RF measurement and the reference (camera optical center/target center) for optical alignment are unified through a precise mechanical interface. The positioning post design ensures the long-term stable operation of the system without the need for complex calibration after each RF antenna installation. A single optical system calibration can be used long-term to guarantee the accuracy of the RF measurement.

The nose-mounted radome is one part of the radar system of an aircraft. It is not only as a protective cover to shield the airborne radar from being damaged by ice, freezing rain, static electricity, lightning, hail, bird strikes, and other debris impact from the air, but also serves as an electromagnetic window to the signals passing through. The radome performance assessment is conducted including transmission efficiency, sidelobe level, beam width, incident reflection, beam deflection, and other environmental and electrical tests. In the related arts, the radome performance is tested under the far-field condition. In a very large microwave anechoic chamber (walls covered with absorbing material to simulate an open environment), the radome and the radar antenna are placed at one end, and a precise receiving antenna is placed at the other end, far away (far field). In embodiments of the present disclosure, the far field refers to a distance large enough that the electromagnetic waves reaching the receiving antenna can be considered as the parallel plane waves. This allows for a realistic simulation of radar wave propagation in the air and accurate measurement of overall radiation characteristics such as beamwidth, sidelobes, and pointing. Far-field testing requires a large test site and is very expensive.

The test system provided in embodiments of the present disclosure can perform near-field testing. Instead of directly measuring the formed beam at a distance, it uses a probe (which can be a horn antenna, such as horn antenna 1 or 2) to scan thousands of points on a plane closely attached to the radome surface, and records the signal characteristics at each point. All the near-field data is then converted and synthesized to simulate the true performance of the radar antenna in the far field (including indicators such as transmission efficiency). High-precision testing can be performed in a relatively small room, making it suitable for maintenance and verification in a workshop.

For example, the method provided in embodiments of the present disclosure includes: installing the radome between the first robot and the second robot, and collecting near-field data of a test signal passing through the radome at the predetermined detection point by the aligned first testing device and second testing device; and obtaining far-field data of the test signal according to the near-field data.

In the near-field area close to the antenna, the near-field data (including amplitude and phase), that is, the amplitude and phase of the test signal before and after passing through the radome, is measured at thousands of points on a closed surface or plane in front of the radome using a precise sampling probe. Then, a mathematical model based on electromagnetic field theory is used to convert the near-field data into a far-field radiation pattern, i.e., the far-field data. Thousands of points mean a very dense grid, sufficient to capture any minute performance inhomogeneities on the radome (such as repairing/reinforcement areas, aging areas, etc.), avoiding defects missed due to insufficient sampling.

If the scanning surface is a plane located in front of the antenna, the Fast Fourier Transform can be performed on the acquired near-field data. This transformation is equivalent to decomposing the measured field distribution into a superposition of countless plane waves propagating in different directions. This “set of plane waves” is called the angular spectrum. The coordinate transformation is performed on the angular spectrum (from the plane-wave direction cosine coordinate system and the spherical angular coordinate system), and the influence of the probe's own directivity is removed. The transformed and compensated angular spectrum is directly the mathematical expression of the far-field radiation pattern. Performing the inverse FFT or direct calculation on it yields the amplitude and phase radiation patterns of the far field. If the scanning surface is a cylindrical surface surrounding the antenna, the cylindrical wave expansion is performed (the Fourier transform in the angular dimension, Fourier-Bessel expansion in the height dimension). The measured field is expanded using the cylindrical harmonic function and then extrapolated to the far field. A complete radiation pattern of the antenna within 360° of the horizontal plane and a certain angle in the vertical plane can be obtained. If the scanning surface is a sphere completely surrounding the antenna, the spherical wave expansion is performed (using the spherical harmonic function and Legendre polynomials). The measured field is expanded using a set of orthogonal spherical wave functions. Once the coefficients are determined, the field at any point in space (including the far field) can be calculated. A complete three-dimensional radiation pattern across the entire antenna space can be obtained.

When a radome is assessed, near-field measurements are first performed on the test antenna alone to obtain its far-field radiation pattern in free space. Then, the radome is installed between the test antennas, and measurements are taken again on the identical near-field sampling surface to obtain the far-field radiation pattern after the radome is installed. By comparing the free-space far-field radiation pattern with the radome-installed far-field radiation pattern, each performance indicator introduced by the radome can be precisely quantified, such as transmission efficiency, also known as insertion phase delay, which represents the power loss of the signal after passing through the radome. The near-field data can be used to inversely calculate the field distribution on the antenna aperture surface. If an anomaly occurs in the aperture field after the radome is installed, the specific area on the radome causing the problem can be precisely located (e.g., a poor bonding point, uneven thickness), which is impossible with the far-field measurement. The controlled indoor environment avoids external environmental interference, resulting in extremely high measurement accuracy. All tests do not radiate sensitive signals outwards, meeting electromagnetic confidentiality requirements.

For example, the method provided in embodiments of the present disclosure includes: generating and emitting the test signal to the first testing device or the second testing device by a vector network analyzer; and receiving the returned test signal from the second testing device or the first testing device by the vector network analyzer.

For example, the measurement distance is less than

$$\frac{2 {D}^{2}}{λ} ,$$

D represents an aperture of the first testing device or the second testing device, and A represents a wavelength of a test signal emitted by the first testing device or the second testing device.

In electromagnetism, based on the distance between the observation point and the antenna, the antenna's radiation field can be divided into three areas: the reactive near-field area, the radiating near-field area, and the far-field area. The near field refers to the reactive near-field area and the radiating near-field area close to the antenna. The reactive near-field area (extreme near-field) is an area closest to the antenna. In this area, electromagnetic energy mainly oscillates (stores and exchanges) between the antenna and the surrounding space, rather than radiating outwards. The radiating near-field area (Fresnel area) is a slightly farther area. Electromagnetic waves begin to radiate primarily outwards, but the wavefront (equiphase surface) is not yet a plane, but a sphere. The amplitude and phase of the field change drastically in space. This stands in contrast to the far field. In the far field area, the electromagnetic waves can be considered plane waves, with a plane wavefront, and the radiation pattern (i.e., the spatial distribution of the signal strength) is stable and no longer changes with distance. Traditional antenna testing is usually conducted in the far field, but this requires a large test distance

$$( distance > \frac{2 {D}^{2}}{λ} ,$$

where D is the antenna aperture and λ is the wavelength).

The test system provided in embodiments of the present disclosure is a radome assessment and transmission test system based on near field measurement. It scans and measures the antenna system equipped with the radome in the near-field area (e.g., the radiating near-field area). For large antennas (such as the airborne fire control radar), achieving far-field conditions requires distances of hundreds or even thousands of meters, making the construction of such test sites extremely difficult and expensive. Near-field measurement can be completed in a microwave anechoic chamber of only a few meters or even smaller. By accurately measuring the amplitude and phase of the electromagnetic field on a plane in the near-field area, transformations (such as “near-field to far-field transformation”) can be used to accurately calculate the antenna's full radiation characteristics (radiation pattern, gain, sidelobes, etc.) in the far field. The near-field data can be used to reconstruct the field distribution on the antenna aperture surface, which is very effective for diagnosing subtle defects such as phase distortion and aiming errors introduced by the radome. It can be precisely determined which part of the radome is causing the performance degradation.

In embodiments of the present disclosure, a measurement probe (e.g., the first testing device) is driven by the robot to move on a plane in front of the radome to measure point by point the amplitude and phase of the electromagnetic waves emitted from the antenna (e.g., the second testing device) inside the radome and transmitted through the radome. The computer then processes this massive amount of near-field data to evaluate indicators such as the transmission efficiency (insertion loss), the beam deflection (aiming error), and radiation pattern distortion of the radome.

For example, the measurement distance is not less than 3λ.

The distance between the two horns in the system should meet the requirement of being less than

$$\frac{2 {D}^{2}}{λ}$$

and not less than 3λ. Assuming the used test radio frequency is 9.375 GHz and the wavelength is 32 mm, the measurement distance between the horns should be no less than 96 mm. Since the core of the design is to create a small-scale system, the distance between the horns is set close to the lower limit. To improve measurement efficiency, the test aircraft radome needs to be scanned and 3D model needs to be reconstructed in advance for the system motion trajectory planning.

For example, the frequency f of the test signal is between 7.0 and 11.2 GHz.

For example, the frequency f of the test signal is 9.375 GHz.

λ=c/f, c=299792458 m/s, when f=9.375 GHz, λ=32 mm.

In the related arts, the testing method for the radome requires the far-field testing method, necessitating the long throw lab (e.g., 100 meters) to simulate the propagation state (plane waves) of the radar waves in real air. Building and operating large microwave anechoic chambers is extremely costly. Logistics, queuing, and testing cycles can last for weeks or even months. Furthermore, differences in testing setups and procedures between different labs can lead to inconsistent results. Additionally, in the related arts, the real airborne weather radar is used as the emission source for testing. A real weather radar is itself an expensive avionics device. Moreover, to prevent harm to personnel from high-power microwave radiation, it must be placed in an electromagnetic chamber that can protect against microwave radiation and ensure safety, that is, a dedicated shielding chamber must be equipped, further increasing costs and space requirements. Therefore, most MRO manufacturers must outsource the testing of repair parts, resulting in long turnaround times and uncontrollable costs.

For example, the first testing device is a test antenna and the second testing device is a metal plate; or the first testing device is the metal plate and the second testing device is the test antenna; or both the first testing device and the second testing device are test antennas; or both the first testing device and the second testing device are antenna arrays including a plurality of test antennas.

For example, the test antenna is a horn antenna.

In embodiments of the present disclosure, by employing the collaborative robot (cobot) and the radar horn antenna fed by the VNA, the system is compact and can be safely used in any environment.

For example, the test antenna is a polarized horn antenna.

For example, to match the designed polarization of the radar, the horn antenna is fixed in a single polarization state during testing. The horn antenna and the VNA can provide the idealized plane wave (collimated by the lens), and the measurement result is the theoretically optimal value.

For example, the test antenna is a linearly polarized horn antenna.

The radar horn antenna is a standard gain antenna, belonging to the waveguide aperture extension structure in the microwave band. It directionally radiates the electromagnetic wave energy (emitting mode) or directionally receives it (receiving mode), achieving free-space waveguide mode conversion and suppressing sidelobes. As a passive sensor, it requires an external signal source (such as the VNA) to operate in cooperation. Its power is ≤0.1 W (safety level), it is low-cost, and can measure parameters such as transmissivity. The horn antenna has good directivity, concentrating energy in one direction for emission or reception from a primary direction. This helps reduce interference from walls in anechoic chambers, improving the measurement signal-to-noise ratio. The horn antenna provides sufficient gain to make the signal strong enough without the excessively narrow beam of a high-gain dish antenna, making it suitable for scanning measurements at close range. Its radiation beam (radiation pattern) is very regular and symmetrical, and can be accurately predicted through the theoretical calculation. A single horn antenna can operate within a wide frequency band, allowing a system to cover multiple test frequency points. The emitting horn antenna has known, stable, and repeatable performance. It is responsible for emitting a plane wavefront as a reference to the radome. The receiving probe (horn antenna) is a high-precision sampler, small in size and physical dimensions (aperture), small enough to resolve even the most subtle electromagnetic field changes in the near field of the radome. Driven by a robot, the receiving probe moves precisely in two or three dimensions in front of the radome, sampling point by point. In the near-field test system, a horn antenna with known performance is used as the emitter, acting as a reliable signal source. Another horn antenna with known performance (usually smaller) is used as the receiving probe, acting as a precise moving measuring instrument. This “dual-horn” configuration, combined with the VNA, constitutes a complete system capable of accurately measuring amplitude and phase, thus providing raw data for subsequent near-field to far-field transformation and radome performance assessment.

The test system in embodiments of the present disclosure adopts the horn antenna, including one horn mode, two horns mode, and several horns in parallel mode, to verify the transmission efficiency of the radome which opens a window for the MRO industry to diagnose the repaired radome in a more convenient way.

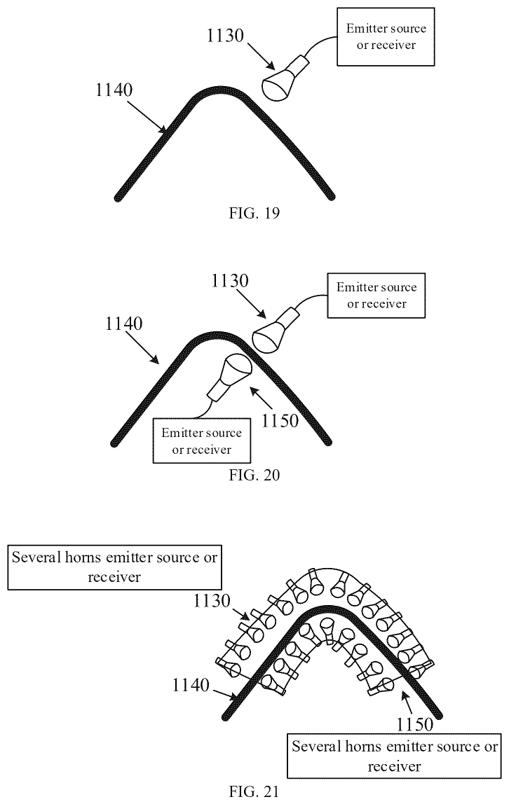

FIG. 19 shows the one horn mode. The one horn mode uses one horn antenna (which can serve as the first testing device 1130) for both emission and reception. This horn antenna is installed on a precision robot (e.g., the first robot 1). A metal plate (not shown) is placed internal side of the radome 1140 on a plane in front of the radome 1140, the movement is performed point-by-point, the double transmission of the radio frequency is measured, a gridded scan of the entire area is completed, and the transmissivity and the phase shift are measured. The system is simple in structure and relatively low in cost. The double transmission means that the test signal emitted by the horn antenna passes through the radome 1140 for the first time (forward transmission), and when encountering the metal plate, it is almost 100% reflected by the metal plate, and the reflected signal passes through the radome 1140 a second time (reverse transmission) and is received by the horn antenna. By comparing the amplitude and phase of the emitted and received signals, the double-path transmissivity and the double-path phase shift at that point are calculated.

The far-field measurement, due to the large size of the specific measurement condition and expensive cost, is more suitable for radome calibration or qualification rather than verification after low-cost maintenance. In the MRO industry, the transmission efficiency of a repaired radome is more important than other electrical performance. In the workshop, as shown in FIG. 19, the one horn mode can be used to measure the transmissivity and phase shift of the radome. The first testing device 1130 (including the horn antenna) can be placed at the external side of a radome 1140 surface and a metal sheet or plate can be placed at the internal side of the radome 1140 as the second testing device to measure the double transmission of the radio frequency.

FIG. 20 shows the two horns mode. The two horns mode uses two horn antennas, serving as the first testing device 1130 and the second testing device 1150, respectively. Embodiments of the present disclosure propose and design an automated radome assessment and transmission test system which aims to help the MRO organization to have the small scale equipment to inspect and assess the repaired radome in the local factory. This system works in the near-field range and uses the double horns measurement mode with two horns placed on both sides of the radome 1140 wall (one as the emitting horn and the other as the receiving horn) to measure the radome wall transmissivity. The signal is emitted from the emitting horn, passes through the radome wall in one go, and is then captured by the receiving horn. The signal penetrates only once, more directly and accurately simulating the penetration process of radar waves in real flight, thus resulting in more accurate and reliable measurement results. This solution is an automatically controlled system with two robot arms. The robot arms can position with millimeter-level or even higher precision, completely eliminating errors caused by human hand tremors, inconsistent placement angles and pressure. The robots can tirelessly and rapidly scan along a preset dense grid path, reducing manual work that would otherwise take hours to just minutes. The robot arm can move flexibly in six dimensions, ensuring that the two horns remain perpendicular to the complex curved surface of the radome and maintain a constant optimal testing distance. This significantly improves efficiency and reliability, and can give a global view of the radome surface in 3D perspective based on the near-field data. Besides that, this system also integrated the function for measuring subsurface of the sandwich structure of the radome via flash thermography.

FIG. 21 shows several horns mode. The several horns in parallel mode uses one or two horn antenna arrays, such as a row of 8 or 16 fixed receiving probes. Data is collected from an entire row in a single mechanical positioning operation by rapidly switching between them via electronic switches. By reducing mechanical movement, the test time can be reduced by an order of magnitude compared to the one horn mode, making it ideal for production lines or high-throughput MRO workshops.

As shown in FIG. 21, the example where both the first testing device 1130 and the second testing device 1150 employ horn antenna arrays is taken, that is, multiple horn antennas are integrated into one array. For example, the number of horn antennas in the first testing device 1130 and the number of horn antennas in the second testing device 1150 can be equal or unequal. For example, the number of emitting horn antennas is less than the number of receiving horn antennas. For example, there can be 2 emitting horn antennas and 16 receiving horn antennas. The system quickly switches between different emitting horn antennas, while all receiving horn antennas receive data in parallel. Through this switching and parallel reception, the system can acquire a large number of data points across the entire scanning plane extremely quickly.

For example, the first testing device and the second testing device are used to perform quality verification on the repaired radome.

For example, the test system provided in embodiments of the present disclosure can be applied to verify the transmissivity of a composite-repaired radome, which can help Maintenance, Repair and Overhaul (MRO) companies improve turnaround time and reduce the total costs of repair.

It should be noted that, since the system provided in embodiments of the present disclosure uses a radar horn antenna rather than a real weather radar, it is impossible to measure sidelobes of the radar and how they are deflected by the radome. However, given that the target user is the MRO industry, such a degree of qualification would not be necessary and accurately assessing the maintenance condition is sufficient to meet their needs.

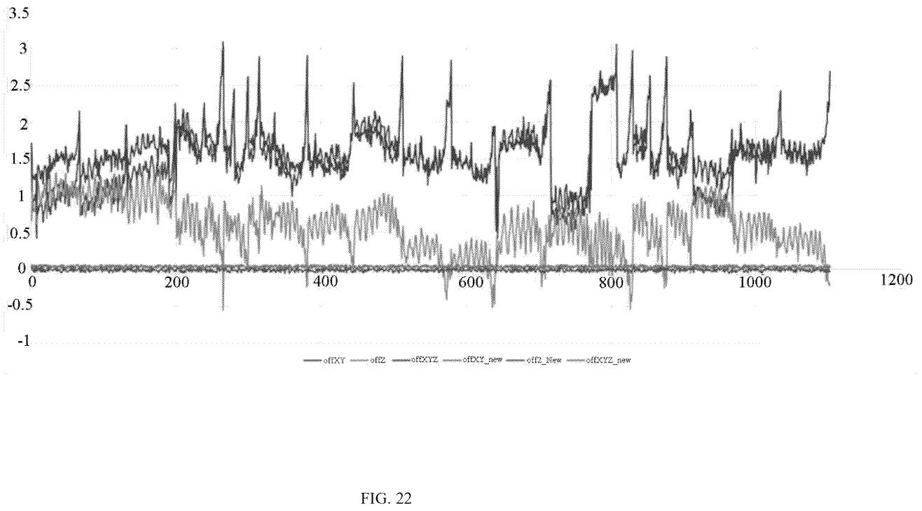

FIG. 22 shows a comparison of the alignment deviation between two uncalibrated horn antennas and the alignment deviation between two calibrated horn antennas. As can be seen from FIG. 22, the alignment deviation is significantly reduced after calibration.

For example, the method provided in embodiments of the present disclosure includes: selecting, according to M measurement directions of an antenna under test, N1 far-field data corresponding to the measurement directions from N far-field data in an elevation and azimuth scanning sequence or an azimuth and elevation scanning sequence, and synthesizing far-field transmissivity in the corresponding measurement directions in a weighted manner, where M and N1 are both positive integers greater than or equal to 1 and less than or equal to N.

For example, the system output is the transmissivity class of the radome which is compiled from the transmissivity values of the radome at 45 different azimuth and elevation angles. These transmissivity values are derived from near-field data collected at approximately 1000 measurement points on the radome surface.

Taking a real 700 mm aperture radar antenna as an example, it has a parabolic surface. When a plane wave (radar echo) reaches this parabola, every point on its surface reflects the electromagnetic wave. All these reflected waves are precisely focused onto a “feed” at the end of the antenna. The total signal ultimately received by the antenna is the sum of the signals received at all points across its entire aperture. However, it is not a simple addition because electromagnetic waves have phase.

In some embodiments, the transmissivity/far-field transmissivity of the real weather radar can be estimated by weighted averaging of values within the field actually covered by the real weather radar. This involves near-field to far-field transformation and weighted averaging. The system synthesizes thousands of near-field data points (the second near-field data) based on the aperture field distribution of the real weather radar antenna by weighted averaging (e.g., a weighting function with a heavier center and lighter edges), thereby obtaining an equivalent transmissivity/far-field transmissivity that represents the performance of the entire radar system.

Embodiments of the present disclosure uses dual robots to perform intensive near-field scanning of the radome, obtaining near-field data from thousands of measurement points on the radome surface. Through weighted averaging, these thousands of near-field data points are synthesized into an equivalent far-field transmissivity simulating that of a real radar in 45 different orientations (45 azimuth/elevation directions). For example, transmissivity class (e.g., Class B) conforming to a standard can also be given based on the results from these 45 directions.

The radome transmission efficiency (TE)/transmissivity is a ratio of the signal power received by the receiving horn antenna with a radome to the signal power received in free space. The captured near-field data is transformed to the far-field data to match 45 measurement positions of the radar gimbal direction. The radar gimbal is a precision mechanical device that supports and drives the rotation of the radar antenna. It allows the antenna to rotate in azimuth and elevation angles, enabling the radar beam to scan the entire sky. A series of representative angle combinations are obtained (e.g., 9 azimuth angles X 5 elevation angles=45 positions). These 45 positions cover the core airspace where the radar beam most frequently operates.

FIG. 23 shows an elevation over azimuth radar gimbal, which is one of the motion scanning sequences. This radome test system is adaptive to both Elevation/Azimuth and Azimuth over Elevation scanning sequences. Elevation over azimuth involves setting an azimuth angle first, then scanning the elevation angle across the entire range; after completion, stepping to the next azimuth angle. Azimuth over elevation involves setting an elevation angle first, then scanning the azimuth angle across the entire range. The test system provided in embodiments of the present disclosure can flexibly synthesize and output far-field transmissivity data at these 45 positions in either of these two sequences, based on standard requirements or user settings. It does not mechanically rotate 45 times, but rather, at the data processing level, virtually calculates the performance impact of the radome when the radar beam points in these 45 different directions from the calculation perspective of adjusting the weighted average. The system generates a report listing the transmissivity at these 45 locations and compares it with the standard requirements to give a final conclusion on whether the repair is qualified.

For example, the assessment and transmission test is performed on a radome, and the TE test result is determined to be Class B. In this test, the radio frequency that the horn antenna adopted is 9.375 GHz. The measurement procedure has been preset and automatically controlled by the software. In TE measurement section, a collaborative robot holding the horn antennas should move to the same position which is in free space and with the radome amounted on the fixture. According to the preset motion path plan, the horn antenna scans the entire electromagnetic window of the radome with around 1200 sampling points. After the signal power in both with and without radome is measured, the TE result can be calculated based on the captured data. When the far-field data from 45 different azimuth and elevation positions are transformed to based on elevation over azimuth scanning sequence, each direction has around 182 sampling points which is capable of covering most of the radome electromagnetic window.

Specifically, in the first round (free space) without the radome installed, the robot, holding the horn, scans along a path of 1200 preset points. The signal power measured in this case is the baseline power under the ideal unobstructed condition. The system accurately records the spatial coordinates of these 1200 points and the corresponding baseline power (the first signal power). In the second round, the radome is installed on the adaptive fixture. Two robots, holding horns, completely reproduce the path of the 1200 points from the first round and scan again. The signal power (the second signal power) measured in this case is the actual power of the signal after passing through the radome. Only by accurately reproducing the path can it be ensured that at each sampling point, the power difference at the same position with and without the radome is being compared. For each of the 1200 points, the system calculates its single-point transmissivity, obtaining 1200 transmissivity data covering the electromagnetic window of the radome. When the far-field transmissivity of the radar beam orienting in a specific direction (e.g., azimuth 10°, elevation 2°) is to be synthesized, not all 1200 points are used. From these 1200 points, the 182 points that contribute the most to the direction are selected (these points exactly cover the “projection” area of the simulated antenna aperture on the radome). Then, based on the aperture field distribution function of the real antenna, each of these 182 points is assigned a weight (center points have higher weights, edge points have lower weights), and finally a weighted average is calculated. This weighted average is the equivalent far-field transmissivity when the radar beam is oriented in this specific direction. The system repeats the above weighted average calculation process for each of the 45 radar gimbal directions specified in the standard. Ultimately, 45 far-field transmissivity values are obtained, respectively representing the impact of the radome on the signal strength when the radar scans different airspaces. The report lists these 45 results, and usually takes the minimum or average value as the basis for determining the final radome class (consistent with the commercial result of Class B).

For example, the method provided in embodiments of the present disclosure includes: mapping transmissivity of each predetermined detection point onto the three-dimensional model of the radome, and obtaining and displaying a transmissivity heat map of the radome.

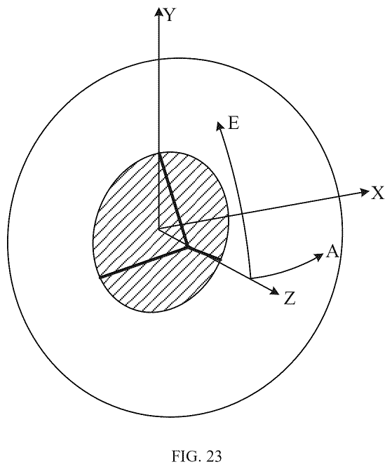

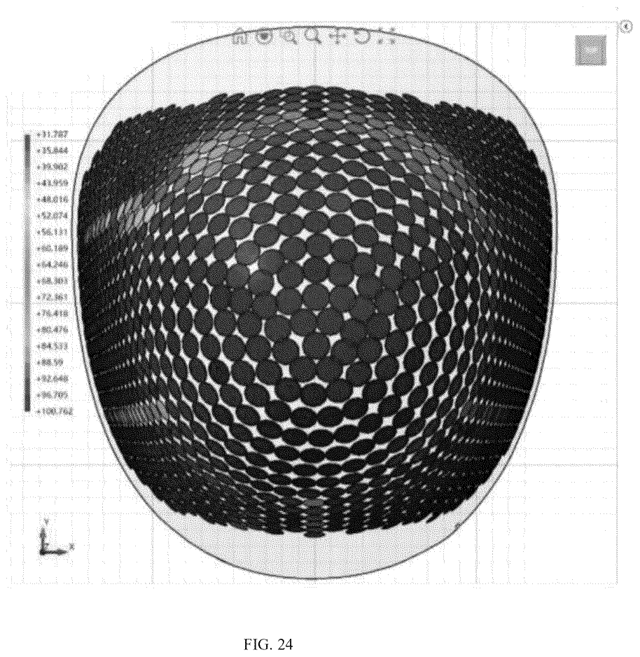

For example, transmissivity heat map as shown in FIG. 24 can be obtained. It maps the transmissivity value of each measurement point onto the 3D model of the radome, and uses colors (e.g., red for low transmissivity, blue for high transmissivity) to visually display the performance distribution of the entire “electromagnetic window”. Maintenance engineers can easily identify areas of weakness and guide precise rework.

The system bonds the acquired transmissivity data from approximately 1200 points to the precise three-dimensional coordinates of predetermined detection points on the radome, and uses different colors to represent different transmissivity value ranges. FIG. 24 shows the three-dimensional display of the Transmission efficiency (TE) results of projecting the transmissivity of each sampling point/predetermined detection point onto the radome's three-dimensional model. The system synthesizes the 1200 near-field data into equivalent far-field transmissivity in 45 far-field directions and uses these far-field results for final classification. The radome tested by this system is classified as Class B, which is the same to the classification that the radome belongs to. The figure shows clearly that the TE results among all sampling points vary from 32 to almost 100 percent. Most sampling points are within the range of 88 to 95 percent, while some area shows a relatively low value on the upper right of the radome, which means in that area the transmission is not as good as other areas. The sampling point on the lightning diverter shows very low transmission result which is reasonable that metal can block most of the RF signal. The lightning diverter is a metal strip embedded in the surface of the radome. Its function is to guide the huge current from a lightning strike to the aircraft fuselage, thereby protecting the inside radar. The measurement results correctly show that the transmissivity of this area is extremely low, proving the physical accuracy and reliability of the measurement system.

Test methods in the related arts typically only provide an overall “pass/fail” or a single class. In addition to the final transmissivity rating, embodiments of the present disclosure further provide a color heat map of transmissivity, visually presenting the transmissivity distribution across the entire radar window area, thus visualizing performance defects and facilitating to position the problem areas. This provides maintenance, repair, and overhaul (MRO) service providers with unique information unavailable with other equipment.

For example, the method provided in embodiments of the present disclosure further includes: illuminating the radome using a flash device (e.g., a flash lamp); recording a temperature change of the radome and obtaining a thermal image of the radome; and detecting a structural integrity of the radome according to the thermal image.

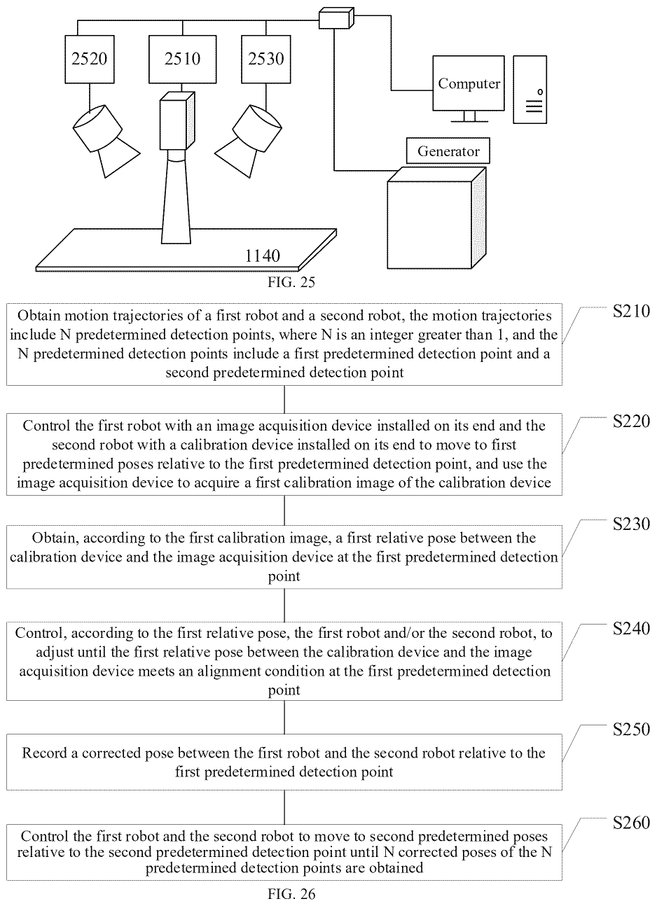

The inside structure of the radome can be assessed via flash thermography using two powerful flash lamps and a high-speed thermal camera. As shown in FIG. 25, the surface of the radar dome/radome 1140 is momentarily heated using two powerful flash lamps 2520 and 2530. A high-speed thermal camera 2510 simultaneously records the cooling process of the surface temperature. If there are inside defects (such as delamination, water accumulation, or collapse of the honeycomb core), the heat dissipation rate of that area will differ from that of intact areas, thus appearing as a “hot spot” or “cold spot” anomaly on the thermal image.

For example, the terahertz imaging technology can be used for non-destructive detection of the inside structure of the radome.

For example, embodiments of the present disclosure provide the radar dome/radome assessment and transmission test system, which mainly includes three robot arms (also referred to as three robots). Two robot arms (e.g., the first robot and the second robot) hold horn antenna 1 and horn antenna 2, respectively, which are precision effectors for performing radio frequency testing. They are responsible for achieving the previously discussed “always perpendicular” and “constant measurement distance”. Through coordinated movement, they can precisely maintain a “test window” on the complex curved surface of the radome, ensuring that each data point/predetermined detection point is acquired under optimal and consistent conditions. Another robot arm (e.g., the third robot) holds one or more of the components shown in FIG. 25, such as flash lamps 2520 and 2530, a thermal camera 2510, a vector network analyzer (VNA), a motion controller, a data processing terminal, and mechanical structures. The flash lamp and the thermal camera are used to perform radome structural defect detection, enabling the system to have dual detection capabilities for electrical performance and structural integrity. The other robot arm can precisely control the distance and angle between the thermal camera and the radome surface, ensuring clear, consistent images and comprehensive coverage of the area to be inspected. The motion controller receives motion trajectory instructions from the data processing terminal and converts them into real-time electrical signals to drive the motion of each robotic joint, ensuring that the three robot arms work smoothly, accurately, and synchronously without interference or collision. The data processing terminal runs the software that controls the entire system, including path planning, instrument control, data acquisition, storage, and final data processing algorithms (such as near-field to far-field transformation, weighted averaging, and generating 3D color cloud map reports).

Qualified modern radomes are normally classed at A (average transmissivity exceeding 90%) or B (average transmissivity exceeding 87%) level representing the average transmissivity over 90 or 87%. This transmissivity must be verified post repair. Current issues in transmissivity measurement is the test for transmissivity of a nose radome is essential for verification of the component post repair while the certification or repair test is currently carried out in a long throw anechoic chamber of which there are only few. For example, for a large airborne radome (e.g., 1 meter in diameter) operating in the X-band (wavelength 0.03 meters), the required far-field test distance is approximately 67 meters. The cost of the test is also rather high. Most composite repair shops do not have access to transmissivity test facility. The newly updated RTCA DO-213A document compared to RTCA DO-213 standard which was published in the year 1995 gives more critical measurement requirements. For example, the far-field reference range increases from D²/2λ to 2D²/λ, a fourfold increase in distance requirement. This change brings far-field radome test suppliers more challenge and increases the test cost. Testing radomes using near-field methods requires only an anechoic chamber capable of housing the radome and a small collaborative robot. This makes it possible for repair shops to build their own test systems. These systems can not only accurately calculate transmissivity but also reconstruct the radar's far-field radiation pattern. Near-field systems can integrate structural scanning capabilities, enabling “one-stop” inspection.

In the aviation maintenance, repair, and overhaul industry, when a radome is repaired, its quality needs to be verified before mounted back to the aircraft. It needs to check the integrity of the honeycomb structure of the radome, and to verify that the transmissivity of the radome meets the standard. But the traditional way to check the radome transmissivity is time consuming and requires far-field test range or an anechoic chamber which the repair shop cannot have access to the high-cost specific transmissivity test facility. Embodiments of the present disclosure provide a small scaled and low-profit near-field test system which is compliant with the updated standard RTCA DO-213A. This system is capable of both assessing both the structural integrity of the radome's interior and verifying the transmissivity of the repaired radome. The interior of a radome typically has a honeycomb structure, which is both lightweight and robust. After repair, these “honeycombs” need to be inspected for flattening, damage, or water ingress. This system also integrates non-destructive testing techniques such as ultrasonic or terahertz, and scans the inside honeycomb structure to ensure no hidden damage is present, while checking the transmissivity.

For example, absorbing foams cover all the fixtures, stands, and equipment in the working area. In RF testing, one of the biggest sources of interference is multipath reflection, that is, electromagnetic waves are reflected back from metal fixtures, stands, or walls, interfering with the main signal. These reflections contaminate the data, causing measurement distortion. Covering with absorbing foam, much like in a microwave anechoic chamber, absorbs these stray reflected waves, ensuring that the VNA measures only the signal that directly penetrates the radome, thus improving measurement accuracy and reliability.

For example, the test antenna is a precisely calibrated linearly polarized antenna, ensuring the stability of relevant signal parameters under test conditions. The precisely calibrated linearly polarized antenna serves as both a emitting and receiving horn; the performance (such as the Voltage Standing Wave Ratio and the gain) of the horn antenna itself is known and stable, and its systematic errors can be corrected during data processing. Linear polarization clearly defines the polarization mode of the electromagnetic wave (such as vertical or horizontal polarization), which is a prerequisite for maintaining consistency with the actual operating mode of airborne radar. Polarization mismatch will lead to measurement errors.

For example, the motion of all motion devices is calibrated using a third-party ranging system to ensure that the captured data is attributed to a finite error range of the hardware components. This third-party ranging system calibration is used to calibrate the actual positions of all motion devices. The robot arm's own positioning accuracy may have errors at the micrometer level. Using a higher-precision external measurement system (such as the laser tracker) to calibrate the robot's actual motion position can quantify and minimize the spatial positioning error of the entire system. This means that the system not only knows where the robot “should” be, but also where it “actually” is, ensuring that each data point has accurate spatial coordinates and ultimately limiting the overall error introduced by the hardware to a known, acceptable range.

The test system provided in embodiments of the present disclosure solves the problems of positioning and repeatability through robotics, addresses environmental electromagnetic interference through the absorbing foam, mitigates instrument inherent errors through the calibrated antenna, and resolves mechanical motion accuracy issues through third-party calibration. This system can generate near-laboratory-grade, repeatable, and highly reliable test data in an MRO workshop environment.

Without an inside testing platform, MRO companies must transport the radome to a third-party laboratory for compliance testing after completing repairs. This results in significant time delays: arranging transportation, transit time, waiting in line for testing, obtaining reports, and then returning it to the MRO workshop. The entire process can easily consume weeks or even months. With the test system provided in embodiments of the present disclosure, the radome can be tested immediately in the workshop after repair. If the initial test fails, engineers can immediately pinpoint the problem, make on-site corrections, and retest within minutes or hours. This avoids the repeated cycles of “repair-external testing-failure-rework”, each potentially wasting weeks. Without waiting for external reports, decisions to continue subsequent processes or release the aircraft can be made quickly based on real-time data. Aircraft downtime is significantly reduced, allowing MRO companies to serve more customers, improving asset turnover, and reducing total costs.

In the radome test system provided in embodiments of the present disclosure, on the one hand, the collaborative robot and the horn antenna fed by the VNA are used to replace the actual radar antenna. The VNA is a general-purpose, low-power testing instrument, significantly cheaper than a dedicated weather radar, and is very safe. Because the low-power VNA is used as the signal emitting source, the system poses no radiation safety risk and can be used in open workshops without the need for a shielded room. The collaborative robot is more flexible and less expensive than customized heavy-duty industrial robots and is suitable for shared workspaces. The test system provided in embodiments of the present disclosure replaces fixed far-field testing with robotic near-field scanning, allowing it to be deployed in ordinary MRO workshops without requiring special facilities, occupying a small area, and can be used to evaluate radome component repairs, precisely targeting the MRO market.

Embodiments of the present disclosure provide a radome assessment and transmission (transmissivity) test system, which is a testing device to determine the radar transmissivity (the percentage of the capability of radar waves penetrating the radome) of the radar dome (radome) component, which is the most forward part of the airframe of a commercial aircraft. For example, the testing method provided in embodiments of the present disclosure utilizes a low-power test signal generated by the VNA to emit a signal at a frequency of 9.375 GHz to a pair of polarized radar horns equipped with plano-convex collimating lenses. These radar horn antennas are installed on the final axis of two collaborative robots. The two collaborative robots are programed in synchrony to follow the contour of the radome at normal incidence (i.e., maintaining a perpendicular incident angle), allowing electromagnetic waves to be incident perpendicularly onto the radome surface. In addition, a small-diameter (e.g., 100 mm) alignment disk/calibration device is used to reduce the risk of robot collisions. For example, the radome is mounted on a rotating turntable/rotation device to allow the collaborative robot to move in a minimal path. For example, cables connecting the radar horn antenna to the VNA are guided along the arms of the collaborative robots. The system records readings in free space and with the radome in place and calculates the transmissivity percentage from the power values obtained from both readings. For example, the transmissivity performance of a weather radar can be estimated by calculating an average of the transmissivity values in the field (measuring points) that the weather radar would cover. In addition, the system produces a colour “heat map” of transmissivity over the radar window area. The entire device is controlled by proprietary software fully developed in-house.

It can be understood that the calibration system and calibration method provided in embodiments of the present disclosure can be applied not only to the calibration of the radome test system, but also to any field that requires dual robots (automated equipment) or multiple robots to achieve precise alignment and high-precision collaborative operation in a multi-axis system, such as similar application scenarios in the automotive or aerospace manufacturing industries, like precision assembly, welding, and inspection.

The testing method provided in the present disclosure includes two processes: benchmark testing without radome and transmissivity testing with radome, each test is initiated by the operator from the control console via single button operation. For example, the base of the test rig is constructed using aluminum beams which are relatively easy to procure, and the transmissivity measurement element includes cobots, radar horn antennas, the VNA and a computer. There are few moving parts in the system with high reliability. By utilizing the calibration system and method provided in embodiments of the present disclosure, the robot or collaborative robot can be aligned and coordinated to work in harmony with near perfect parallelism and orientation. This is most useful in the application of the radome test rig where the two radar horn antennas are ensured to be pointing at each other with a high degree of alignment at an angle to axis 6 in order to maximize the signal transmission. The radar horns carried by the collaborative robot are also orientated in the rotation plane to allow for alignment of the polarized radar beam.

Embodiments of the present disclosure provide a project to manufacture and test a near-field, small footprint test rig which can simulate the results of a far-field test range and complete the test of a radome in under 10 hours. The radio frequency (RF) signal (9.375 GHz) was fed to the radar horns from a low-power VNA. Measurement of the radar transmissivity was carried in two stages, radome off and radome on. The values recorded were converted to power and the percentage transmissivity revealed for over a thousand points. The weighted averaging is performed on the transmissivity of these points to simulate a result that the signal was received by a full-size (e.g., 700 mm aperture) airborne radar antenna.

The system provided in embodiments of the present disclosure achieves a miniaturized design with a small footprint (e.g., only 2m×3m), allowing for deployment in limited spaces within a repair shop and easy mobility. Instead of using the weather radar, a Vector Network Analyzer (VNA) is employed, which means that the test rig is cheaper and safe to use in an open environment. The cost is relatively low, approximately 1/10 of traditional solutions. The scan of the radome produces around one thousand data points giving a very useful performance distribution map of the radome for the MRO entity to use.

a colour transmissivity heat map of high granularity is generated, visually displaying the radome transmissivity distribution. Low-power VNA signals are used, with tightly controlled power. Full measurement is completed in one shift (e.g., within 8 hours), significantly improving maintenance efficiency. The use of the modular architecture reduces supply chain risks. The maintenance requirements are low, and the downtime cost is reduced. The single button operation is achieved, and fully automated testing is enabled with a single click, lowering the operational threshold. For example, feature point recognition can be used to automatically identify radome curved surface features via machine vision, adapting to different models. Collision avoidance path planning is also possible. For example, dynamic tilt control can also be implemented to adjust the pitch/yaw angle of the test antenna in real time to maintain the beam perpendicular incidence. The displacement control of the robot is performed, and alignment optimization and simplification are achieved. For example, the antenna orientation can be optimized in real time using a proportional-integral algorithm to suppress accumulated errors.

The entire test process for a radome takes about 5 hours. Another test carried out for a radome which is bigger in size can be finished in about 9 hours. From the perspective of effectiveness, the proposed new radome assessment and transmission test system is far more efficient compared to the traditional far field measurement method, especially when the MRO company cannot afford the expensive far field RF measurement equipment and have to ship the radomes to other cities or even other countries to get a valid certification. While the system proposed in embodiments of the present disclosure can help the MRO industry to finish the maintenance and validation within the workshop. The system can accelerate the production flow efficiency for the MRO industry.

The radome assessment and transmission test system based on near field measurement proposed in embodiments of the present disclosure is based on the newly updated RTCA DO-213A criterion. It allows the MRO industry to have a low cost, small size radome transmission measurement facility, which is equipped in the shop floor. The entire system has been established and well calibrated. Two types of radome for commercial use in service have been tested. The overall processing time for those radomes is within 10 hours which less than 2 shifts in the factory. The test result shows the system correlate with the conventional range. The efficiency and effectiveness of the system is much better than the traditional way that MRO industry used for now. Since this solution is specifically designed for radome measurement after repair, especially TE result verification for MRO industry, it is not suitable for radome certification or qualification.

When the radar horn is used in the near field or Fresnel area (as opposed to the far field), the coherence length of the radiation must be taken into account. The coherence length is found in the near field and is given as approximately 400 mm.

The method provided in an embodiment of FIG. 26 can be executed by a controller or any electronic device. As shown in FIG. 26, the method provided in embodiments of the present disclosure includes the following steps.

In S210, motion trajectories of a first robot and a second robot are obtained, the motion trajectories include N predetermined detection points, where N is an integer greater than 1, and the N predetermined detection points include a first predetermined detection point and a second predetermined detection point.

In S220, the first robot with an image acquisition device installed on its end and the second robot with a calibration device installed on its end are controlled to move to first predetermined poses relative to the first predetermined detection point, and the image acquisition device is used to acquire a first calibration image of the calibration device.

In S230, a first relative pose between the calibration device and the image acquisition device at the first predetermined detection point is obtained according to the first calibration image.

In S240, the first robot and/or the second robot are controlled, according to the first relative pose, to adjust until the first relative pose between the calibration device and the image acquisition device meets an alignment condition at the first predetermined detection point

In S250, a corrected pose between the first robot and the second robot relative to the first predetermined detection point is recorded.

In S260, the first robot and the second robot are controlled to move to second predetermined poses relative to the second predetermined detection point until N corrected poses of the N predetermined detection points are obtained.

For example, the motion trajectory is on a curved surface. The method provided in embodiments of the present disclosure further includes: determining a first normal line of the first predetermined detection point on the curved surface; and when an angle between an axis of the image acquisition device and the first normal line and an angle between an axis of the calibration device and the first normal line are both less than a first angle threshold, an angle between a first horizontal axis of the image acquisition device and a first horizontal axis of the calibration device is less than a second angle threshold, and a deviation between an origin of the image acquisition device and an origin of the calibration device in a plane of the first horizontal axis and a second horizontal axis is less than a predetermined threshold, determining that the first relative pose between the calibration device and the image acquisition device meets the alignment condition at the first predetermined detection point.

For example, the method provided in embodiments of the present disclosure include: obtaining a first transformation matrix from the image acquisition device to its first tool center point and an optical correction parameter of the image acquisition device; obtaining a second transformation matrix from the calibration device to its second tool center point; and obtaining the first relative pose based on the first calibration image, the first transformation matrix, the optical correction parameter, and the second transformation matrix.

For example, obtaining the first transformation matrix from the image acquisition device to its first tool center point and the optical correction parameter of the image acquisition device includes: controlling the second robot to move to a first position to keep the calibration device fixed; controlling the first robot to move to a plurality of different first preset poses, and controlling the image acquisition device to acquire, in the different first preset poses, first images of the calibration device, respectively; and obtaining the first transformation matrix and the optical correction parameter based on the first images for the different first preset poses.

For example, obtaining the second transformation matrix from the calibration device to its second tool center point includes: controlling the first robot to move to a second position to keep the image acquisition device fixed; controlling the second robot to move to a plurality of different second preset poses, and controlling the image acquisition device to acquire second images of the calibration device in the different second preset poses, respectively; and obtaining the second transformation matrix based on the second images for the different second preset poses.

For other content of the embodiment shown in FIG. 26, reference may be made to other embodiments, which will not be repeated here.

The method provided in embodiments of the present disclosure can also be extended to a multi-robot system.

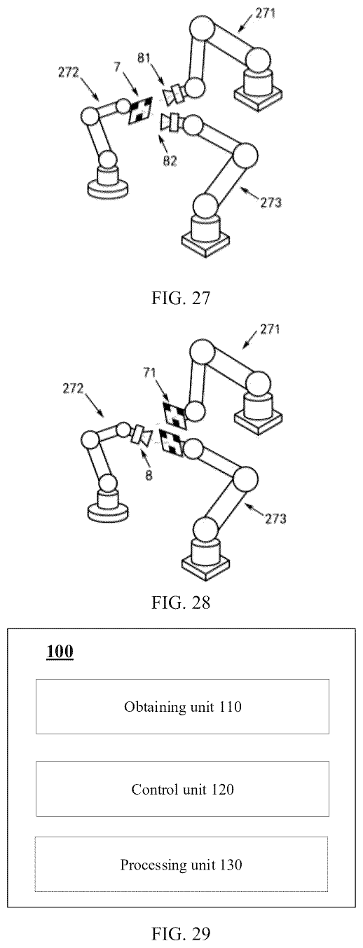

FIGS. 27 and 28 take three robots as an example. In the embodiment shown in FIG. 27, the first robot 271 has a first image acquisition device 81 installed at its end, the second robot 272 has a calibration device 7 installed at its end, and the third robot 273 has a second image acquisition device 82 installed at its end. That is, two of the three robots have cameras installed, and one robot has a calibration board installed. Alternatively, as shown in FIG. 28, the first robot 271 has a first calibration device 71 installed at its end, the second robot 272 has an image acquisition device 8 installed at its end, and the third robot 273 has a second calibration device 72 installed at its end. That is, two of the three robots have calibration boards installed, and one robot has a camera installed.

In embodiments of the present disclosure, calibration for any configuration of a multi-robot system can be performed according to the following steps, which mainly consist of three steps.

In the first step, a second transformation matrix T2 from the optical calibration board/calibration device to the TCP of the second robot is calculated. This step selects a camera on another robot as the camera for hand-eye calibration, achieving eye-on-hand calibration, where the camera remains stationary while the calibration board moves to multiple positions to capture images. This step can reduce the measurement error from the calibration board to the TCP of the second robot.

In the second step, a first transformation matrix T1 from the camera to the TCP of the robot is calculated. In this step, a calibration board from another robot is selected as the calibration board for hand-eye calibration, achieving eye-on-hand calibration. That is, the calibration board remains stationary while the camera moves to multiple positions to capture images. This step can reduce the measurement error from the camera to the TCP.

In the third step, the system's working orientation deviation is corrected. In this case, the robot is moved to the working position. The orientation of one robot is fixed as needed, while the other robots are moved so that the standard board and the camera are close to the target transformation matrix T3 (i.e., the ideal pose), thus achieving system alignment.

For the multi-robot system, calibration boards can be installed on TCPs of one or more robots, while cameras are installed on TCPs of other robots. Depending on the requirements, one robot can be selected from multiple robots as the fixed target (either the camera or the calibration board), and then the relative poses of the other robots are corrected and compensated. If multiple robots need to align a target in space (e.g., the reference point orientation of a workpiece), additional calibration boards can be placed on the workpiece. First, one or more robots with cameras are selected to compensate for their orientation deviation relative to the workpiece calibration board. Then, one or more robots (with cameras) are fixed and the other robots (with calibration boards) are compensated.

As shown in FIG. 29, embodiments of the present disclosure provide a calibration apparatus 100, including: an obtaining unit 110, configured to obtain motion trajectories of a first robot and a second robot, the motion trajectories include N predetermined detection points, where N is an integer greater than 1, and the N predetermined detection points include a first predetermined detection point and a second predetermined detection point; a control unit 120, configured to control the first robot with an image acquisition device installed on its end and the second robot with a calibration device installed on its end to move to first predetermined poses relative to the first predetermined detection point, and use the image acquisition device to acquire a first calibration image of the calibration device; a processing unit 130, configured to obtain, according to the first calibration image, a first relative pose between the calibration device and the image acquisition device at the first predetermined detection point; the control unit 120, further configured to control, according to the first relative pose, the first robot and/or the second robot to adjust until the first relative pose between the calibration device and the image acquisition device meets an alignment condition at the first predetermined detection point; the processing unit 130, further configured to record a corrected pose between the first robot and the second robot relative to the first predetermined detection point; and the control unit 120, further configured to control the first robot and the second robot to move to second predetermined poses relative to the second predetermined detection point until N corrected poses of the N predetermined detection points are obtained.

For other content of the embodiment shown in FIG. 29, reference can be made to the above embodiments, which will not be repeated here.

Embodiments of the present disclosure further provide a calibration system, including: a first robot and a second robot; an image acquisition device installed at an end of the first robot, and a calibration device installed at an end of the second robot; and a controller, configured to: obtain motion trajectories of the first robot and the second robot, wherein the motion trajectories include N predetermined detection points, where N is an integer greater than 1, and the N predetermined detection points include a first predetermined detection point and a second predetermined detection point; control the first robot with the image acquisition device installed on its end and the second robot with the calibration device installed on its end to move to first predetermined poses relative to the first predetermined detection point, and use the image acquisition device to acquire a first calibration image of the calibration device; obtain, according to the first calibration image, a first relative pose between the calibration device and the image acquisition device at the first predetermined detection point; control, according to the first relative pose, the first robot and/or the second robot to adjust until the first relative pose between the calibration device and the image acquisition device meets an alignment condition at the first predetermined detection point; record a corrected pose between the first robot and the second robot relative to the first predetermined detection point; and control the first robot and the second robot to move to second predetermined poses relative to the second predetermined detection point until N corrected poses of the N predetermined detection points are obtained.

For example, the controller is further configured to: control the second robot to move to a first position to keep the calibration device fixed; control the first robot to move to a plurality of different first preset poses, and control the image acquisition device to acquire, in different first preset poses, first images of the calibration device in the different first preset poses, respectively; obtain a first transformation matrix from the image acquisition device to its first tool center point and an optical correction parameter of the image acquisition device based on the first images for the different first preset poses; control the first robot to move to a second position to keep the image acquisition device fixed; control the second robot to move to a plurality of different second preset poses, and control the image acquisition device to acquire second images of the calibration device in the different second preset poses, respectively; obtain a second transformation matrix from the calibration device to a second tool center point of the second robot based on the second images for the different second preset poses; and obtain the first relative pose based on the first calibration image, the first transformation matrix, the optical correction parameter, and the second transformation matrix.

For example, the calibration device includes a checkerboard-and-coded-marker hybrid calibration pattern.

For example, the end of the first robot includes a first mounting bracket, and the end of the second robot includes a second mounting bracket; and the image acquisition device is installed on the first mounting bracket via a first fixed adapter, and the calibration device is installed on the second mounting bracket via a second fixed adapter.

For example, the first mounting bracket is further used to install a first testing device, and the second mounting bracket is further used to install a second testing device; the controller is further configured to move the first robot and the second robot according to the motion trajectories and the corrected pose to align the first testing device and the second testing device at the predetermined detection point; and the first testing device and the second testing device are configured to detect the radome at the N predetermined detection points.

For example, the calibration system further includes: a flash device, configured to illuminate the radome; and a recording device, configured to record a temperature change of the radome and obtain a thermal image of the radome; the controller is further configured to detect a structural integrity of the radome according to the thermal image.

For example, the calibration system further includes a rotation device, configured to install and rotate the radome.

For example, embodiments of the present disclosure further provide an electronic device, including: one or more processors; and a memory configured to store one or more programs, which, when executed by the one or more processors, cause the electronic device to implement the method described in any embodiment of the present disclosure.

For example, embodiments of the present disclosure further provide a computer-readable storage medium storing a computer program that, when run on a computer, causes the computer to perform the method described in any embodiment of the present disclosure.

For example, embodiments of the present disclosure further provide a computer program product, including a computer program that, when executed by a processor, implements the method described in any embodiment of the present disclosure.

It should be understood that the processor in embodiments of the present disclosure may be an integrated circuit chip with signal processing capabilities. In implementation, the steps of the above method embodiments can be completed by integrated logic circuits in the processor's hardware or by software instructions. For brevity, further details are omitted here.

What is claimed is:

1. A calibration method, comprising:
installing an image acquisition device at an end of a first robot and a calibration device at an end of a second robot;
obtaining motion trajectories of the first robot and the second robot, wherein the motion trajectories correspond to N predetermined detection points, where N is an integer greater than 1, and the N predetermined detection points comprise a first predetermined detection point and a second predetermined detection point;
controlling the first robot and the second robot to move to first predetermined poses relative to the first predetermined detection point, and using the image acquisition device to acquire a first calibration image of the calibration device;
obtaining, according to the first calibration image, a first relative pose between the calibration device and the image acquisition device at the first predetermined detection point;
controlling, according to the first relative pose, at least one of the first robot or the second robot to adjust until the first relative pose between the calibration device and the image acquisition device meets an alignment condition at the first predetermined detection point;
recording a corrected pose between the first robot and the second robot relative to the first predetermined detection point; and
controlling the first robot and the second robot to move to second predetermined poses relative to the second predetermined detection point until N corrected poses of the N predetermined detection points are obtained.

2. The method according to claim 1, wherein the motion trajectories are on a curved surface, and the method further comprises:
determining a first normal line of the first predetermined detection point on the curved surface; and
in response to determining that an angle between an axis of the image acquisition device and the first normal line and an angle between an axis of the calibration device and the first normal line are both less than a first angle threshold, an angle between a first horizontal axis of the image acquisition device and a first horizontal axis of the calibration device is less than a second angle threshold, and a deviation between an origin of the image acquisition device and an origin of the calibration device in a plane of the first horizontal axis and a second horizontal axis is less than a predetermined threshold, determining that the first relative pose between the calibration device and the image acquisition device meets the alignment condition at the first predetermined detection point.

3. The method according to claim 1, further comprising:
obtaining a first transformation matrix from the image acquisition device to its first tool center point and an optical correction parameter of the image acquisition device; and
obtaining a second transformation matrix from the calibration device to its second tool center point;
wherein the first relative pose is obtained based on the first calibration image, the first transformation matrix, the optical correction parameter, and the second transformation matrix.

4. The method according to claim 3, wherein obtaining the first transformation matrix from the image acquisition device to its first tool center point and the optical correction parameter of the image acquisition device comprises:
controlling the second robot to move to a first position to keep the calibration device fixed;
controlling the first robot to move to a plurality of different first preset poses, and controlling the image acquisition device to acquire, in the different first preset poses, first images of the calibration device, respectively; and
obtaining the first transformation matrix and the optical correction parameter based on the first images for the different first preset poses.

5. The method according to claim 3, wherein obtaining the second transformation matrix from the calibration device to its second tool center point comprises:
controlling the first robot to move to a second position to keep the image acquisition device fixed;
controlling the second robot to move to a plurality of different second preset poses, and controlling the image acquisition device to acquire second images of the calibration device in different second preset poses, respectively; and
obtaining the second transformation matrix based on the second images for the different second preset poses.

6. The method according to claim 1, wherein the calibration device comprises a checkerboard-and-coded-marker hybrid calibration pattern.

7. The method according to claim 1, wherein the end of the first robot comprises a first mounting bracket, the end of the second robot comprises a second mounting bracket, and installing the image acquisition device at the end of the first robot and the calibration device at the end of the second robot comprises:
removing a radome between the first robot and the second robot; and
installing the image acquisition device on the first mounting bracket via a first fixed adapter, and the calibration device on the second mounting bracket via a second fixed adapter.

8. The method according to claim 7, wherein obtaining the motion trajectories of the first robot and the second robot comprises:
obtaining a three-dimensional model of the radome;
planning a scanning path of the radome according to the three-dimensional model, and determining the N predetermined detection points on the scanning path and a normal direction at each predetermined detection point; and
generating, according to the normal direction and a set measurement distance between a first testing device and a second testing device, arrival poses of a first tool center point of the first robot and a second tool center point of the second robot to generate the motion trajectories.

9. The method according to claim 7, further comprising:
removing the image acquisition device from the first mounting bracket and the calibration device from the second mounting bracket;
installing a first testing device on the first mounting bracket and a second testing device on the second mounting bracket; and
moving the first robot and the second robot according to the motion trajectories and the corrected pose to align the first testing device and the second testing device at a predetermined detection point, and detecting the radome at the N predetermined detection points by the first testing device and the second testing device.

10. The method according to claim 9, further comprising:
when the radome is not installed between the first robot and the second robot, collecting a first signal power of a test signal at the predetermined detection point by the aligned first testing device and second testing device;
installing the radome between the first robot and the second robot, and collecting a second signal power of the test signal passing through the radome at the predetermined detection point by the aligned first testing device and second testing device; and
obtaining transmissivity of the radome at the predetermined detection point according to the first signal power and the second signal power.

11. The method according to claim 10, further comprising:
mapping transmissivity of each predetermined detection point onto a three-dimensional model of the radome, and obtaining and displaying a transmissivity heat map of the radome.

12. The method according to claim 9, further comprising:
installing the radome between the first robot and the second robot, and collecting near-field data of a test signal passing through the radome at the predetermined detection point by the aligned first testing device and second testing device; and
obtaining far-field data of the test signal according to the near-field data.

13. The method according to claim 12, further comprising:
selecting, according to M measurement directions of an antenna under test, N1 far-field data corresponding to the measurement directions from N far-field data in an elevation and azimuth scanning sequence or an azimuth and elevation scanning sequence, and synthesizing far-field transmissivity in the corresponding measurement directions in a weighted manner,
where M and N1 are both positive integers greater than or equal to 1 and less than or equal to N.

14. The method according to claim 10, further comprising:
generating and emitting the test signal to the first testing device or the second testing device by a vector network analyzer; and
receiving the returned test signal from the second testing device or the first testing device by the vector network analyzer.

15. The method according to claim 8, wherein the measurement distance is less than
$$\frac{2 {D}^{2}}{λ} ,$$
where D represents an aperture of the first testing device or the second testing device, and λ represents a wavelength of a test signal emitted by the first testing device or the second testing device;
the measurement distance is not less than 3λ; and
a frequency of the test signal is between 7.0 and 11.2 GHz.

16. The method according to claim 8, wherein:
the first testing device is a test antenna and the second testing device is a metal plate;
the first testing device is the metal plate and the second testing device is the test antenna;
the first testing device and the second testing device are both test antennas; or
the first testing device and the second testing device are both antenna arrays comprising a plurality of test antennas; and
the test antenna is a horn antenna.

17. The method according to claim 9, further comprising:
illuminating the radome using a flash device;
recording a temperature change of the radome and obtaining a thermal image of the radome; and
detecting a structural integrity of the radome according to the thermal image.

18. The method according to claim 9, further comprising:
installing the radome on a rotation device; and
rotating the radome by the rotation device, and detecting transmissivity of predetermined detection points in different areas of the radome using the first testing device and the second testing device.

19. A calibration system, comprising:
a first robot and a second robot;
an image acquisition device installed at an end of the first robot, and a calibration device installed at an end of the second robot; and
a controller, configured to:
obtain motion trajectories of the first robot and the second robot, wherein the motion trajectories comprise N predetermined detection points, where N is an integer greater than 1, and the N predetermined detection points comprise a first predetermined detection point and a second predetermined detection point;
control the first robot with the image acquisition device installed on its end and the second robot with the calibration device installed on its end to move to first predetermined poses relative to the first predetermined detection point, and use the image acquisition device to acquire a first calibration image of the calibration device;
obtain, according to the first calibration image, a first relative pose between the calibration device and the image acquisition device at the first predetermined detection point;
control, according to the first relative pose, the first robot and/or the second robot to adjust until the first relative pose between the calibration device and the image acquisition device meets an alignment condition at the first predetermined detection point;
record a corrected pose between the first robot and the second robot relative to the first predetermined detection point; and
control the first robot and the second robot to move to second predetermined poses relative to the second predetermined detection point until N corrected poses of the N predetermined detection points are obtained.

20. An electronic device, comprising:
one or more processors; and
a memory configured to store one or more programs that, when executed by the one or more processors, cause the electronic device to implement the following operations:
installing an image acquisition device at an end of a first robot and a calibration device at an end of a second robot;
obtaining motion trajectories of the first robot and the second robot, wherein the motion trajectories correspond to N predetermined detection points, where N is an integer greater than 1, and the N predetermined detection points comprise a first predetermined detection point and a second predetermined detection point;
controlling the first robot and the second robot to move to first predetermined poses relative to the first predetermined detection point, and using the image acquisition device to acquire a first calibration image of the calibration device;
obtaining, according to the first calibration image, a first relative pose between the calibration device and the image acquisition device at the first predetermined detection point;
controlling, according to the first relative pose, at least one of the first robot or the second robot to adjust until the first relative pose between the calibration device and the image acquisition device meets an alignment condition at the first predetermined detection point;
recording a corrected pose between the first robot and the second robot relative to the first predetermined detection point; and
controlling the first robot and the second robot to move to second predetermined poses relative to the second predetermined detection point until N corrected poses of the N predetermined detection points are obtained.
